(19) United States
(12) Patent Application Publication
(10) Pub. No.: US 2022/0057541 A1
(43) Pub. Date: Feb. 24, 2022

(54) Intelligent Tool Detection Systems And Methods

(71) Applicant: Pico MES Inc., San Francisco, CA (US)

(72) Inventors: Ryan Kuhlenbeck, San Francisco, CA (US); Geoffrey Bucks, Seattle, WA (US); Zachary Nelson, San Mateo, CA (US); Alan Gilder, Burlingame, CA (US)

(21) Appl. No.: 17/001,475

(22) Filed: Aug. 24, 2020

(51) Int. Cl. G01V 3/10; B25H 3/06; G05B 19/406

(52) U.S. Cl. CPC G01V 3/101; B25H 3/06; G05B 2219/50253; G05B 2219/37494; G05B 2219/37004; G05B 19/406

(57) ABSTRACT

Systems and methods for intelligent tool detection are described. One embodiment includes a remote server, a processing system communicatively coupled to the remote server, and a tool tray communicatively coupled to the processing system. The tool tray is configured to store a plurality of tools, and to detect whether a tool has been removed from the tool tray. The tool tray is configured to communicate information associated with the removal of the tool to the processing system. The processing system is configured to communicate the information to the remote server.

### BACKGROUND

### Technical Field

The present disclosure relates to systems and methods that intelligently determine whether one or more tools have been removed from a designated storage area such as a tool tray.

### Background Art

Assembly lines or manufacturing processes include machines such as torque tools or robots that use one or more tools to implement the associated assembly (or manufacturing) process. These machines sometimes need to switch tools such as drill bits or sockets during the assembly process, and there is a risk that a wrong tool may be selected either by a user of the machine or by an automated process that controls the machine. This wrong tool selection, in turn, can cause several problems, including incorrect assembly, damage to the product being assembled, damage to the tool, damage to the machine, and so on. There exists a need, therefore, for a system that is automatically able to determine a selection of a specific tool, and issue an alert if an incorrect tool is selected.

### SUMMARY

Embodiments of apparatuses configured to perform intelligent tool detection may include: a remote server; a processing system communicatively coupled to the remote server; and a tool tray communicatively coupled to the processing system. The tool tray stores a plurality of tools, and detects whether a tool has been removed from the tool tray. The tool tray communicates information associated with the removal of the tool to the processing system, and the processing system communicates the information to the remote server. In some embodiments, the detection of a removal of a tool is performed by the processing system, and the processing system communicates information associated with the removal to the remote server.

Embodiments of apparatuses configured to perform intelligent tool detection may include one or all or any of the following:

A plurality of tool trays, where each tool tray is communicatively coupled with a processing system, with each processing system being communicatively coupled with the remote server.

The detection is performed using one or more inductive sensors.

The inductive sensor includes resonant circuit that is comprised of an inductor and a capacitor.

The inductor being created from a PCB spiral.

The resonant circuit operates within a resonant frequency range of 1 MHz to 10 MHz.

The inductive sensor detects a tool that is within a 5 mm distance of the inductive sensor.

The tools are any combination of drill bits, a pair of pliers, a wrench, a screwdriver, a punch, or any other metallic object.

The remote server determines a type of a tool that has been removed from the tool tray.

The remote server disables a machine, records an event for time sequencing, or sets an alert responsive to an incorrect tool being removed (e.g., an incorrect drill bit).

The basic structure can be extended to include a plurality of machines where each machine is associated with a tool set, and a plurality of tool trays, where each tool tray is associated with a machine. Each tool tray is configured to store a tool set associated with a machine. The processing system is communicatively coupled to each tool tray, and each tool tray detects a removal of a tool from a tool set associated with the tool tray. The tool tray communicates information associated with the removal to the processing system, and the processing system communicates the information to the remote server. The remote server disables one or more machines, records an event for time sequencing, or sets an alert responsive to the remote server determining that an incorrect tool has been removed.

Embodiments of methods configured to perform intelligent tool detection may include a tool tray that monitors a status of a plurality of tools stored in the tool tray. The tool tray detects a removal of a tool from the tool tray, and communicates to a processing system communicatively coupled to the tool tray, information associated with the removal of the tool. The processing system transmits the information to a remote server that is communicatively coupled to the processing system. In some embodiments, the detection of a removal of a tool is performed by the processing system. The processing system communicates information associated with the removal to the remote server.

Embodiments of methods configured to perform intelligent tool detection may include the processing system being communicatively coupled with the remote server using a WiFi communication link.

Embodiments of a method to perform a calibration and learning of an intelligent tool detection system may include one or more of the following:

A user placing a tool in a tool tray; the tool tray detecting a presence of the tool; the tool tray communicating information associated with the presence of the tool to a processing system that is communicatively coupled to the tool tray; the user removing the tool from the tool tray; the tool tray detecting the removal of the tool; the tool tray communicating information associated with the removal of the tool to the processing system; and the processing system learning a distinction between information associated with the tool being present in the tool tray and information associated with the tool being removed from the tool tray.

Embodiments of methods configured to perform a calibration and learning of an intelligent tool detection system may also include the user repeatedly placing the tool in the tool tray and removing the tool from the tool tray multiple times, where the processing system reinforces the learning responsive to the placing and the removing.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 is a block diagram depicting an embodiment of an intelligent tool detection system.

FIG. 2 is a block diagram depicting another embodiment of an intelligent tool detection system.

FIG. 3 is a block diagram depicting another embodiment of an intelligent tool detection system.

FIG. 4 is a block diagram depicting another embodiment of an intelligent tool detection system.

FIG. 5 is a block diagram depicting an embodiment of a processing system that may be used to implement certain functions of an intelligent tool detection system.

FIG. 6 is a block diagram depicting an embodiment of an artificial intelligence module.

FIG. 7 is a schematic diagram depicting an embodiment of an inductive sensor.

FIGS. 8A and B are flow diagrams depicting embodiments of two different methods to detect a removal of a tool from a tool tray and transmit information associated with the removal to a remote server.

FIG. 9 is a block diagram depicting an embodiment of a circuit used to implement an intelligent tool detection system.

FIG. 10 is a block diagram depicting an embodiment of a circuit used to host a WiFi network.

FIG. 11 is a block diagram depicting an embodiment of a circuit that includes multiple inductive sensors.

FIG. 12A is a schematic diagram depicting a top view of an embodiment of a tool tray.

FIG. 12B is a schematic diagram depicting a cross-sectional side view of a tool tray.

FIG. 12C is a schematic diagram depicting a cross-sectional side view of a tool tray with a drill bit.

FIG. 13 is a block diagram depicting an embodiment of a tool holder.

FIG. 14 is a flow diagram depicting an embodiment of a method used to implement a learning sequence.

FIG. 15 is a block diagram depicting an embodiment of a star topology.

FIG. 16 is a block diagram depicting an embodiment of a ring topology.

FIG. 17 is a block diagram depicting an embodiment of an intelligent tool detection system with a switching functionality.

FIG. 18 is a block diagram depicting an embodiment of a method to disable a machine.

FIG. 19 is a flow diagram depicting an embodiment of a method to calibrate an intelligent tool detection system.

FIG. 20 is a flow diagram depicting an embodiment of a method to implement a learning process.

### DETAILED DESCRIPTION

In the following description, reference is made to the accompanying drawings that form a part thereof, and in which is shown by way of illustration specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, a magnetic storage device, and any other storage medium now known or hereafter discovered. Computer program code for carrying out operations of the present disclosure may be written in any combination of one or more programming languages. Such code may be compiled from source code to computer-readable assembly language or machine code suitable for the device or computer on which the code will be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

The flow diagrams and block diagrams in the attached figures illustrate the architecture, functionality, and operation of possible implementations of systems, methods, and computer program products according to various embodiments of the present disclosure. In this regard, each block in the flow diagrams or block diagrams may represent a module, segment, or portion of code, which includes one or more executable instructions for implementing the specified logical function(s). It will also be noted that each block of the block diagrams and/or flow diagrams, and combinations of blocks in the block diagrams and/or flow diagrams, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow diagram and/or block diagram block or blocks.

The systems and methods described herein relate to intelligently detecting a removal of one or more tools from a tool tray. In some embodiments, the tool tray is associated with one or more machines that function as a part of a manufacturing process or an assembly line. Some embodiments may be configured to disable one or more machines, record an event for time sequencing, or set an alert in an event that an incorrect tool is selected by any of the machines.

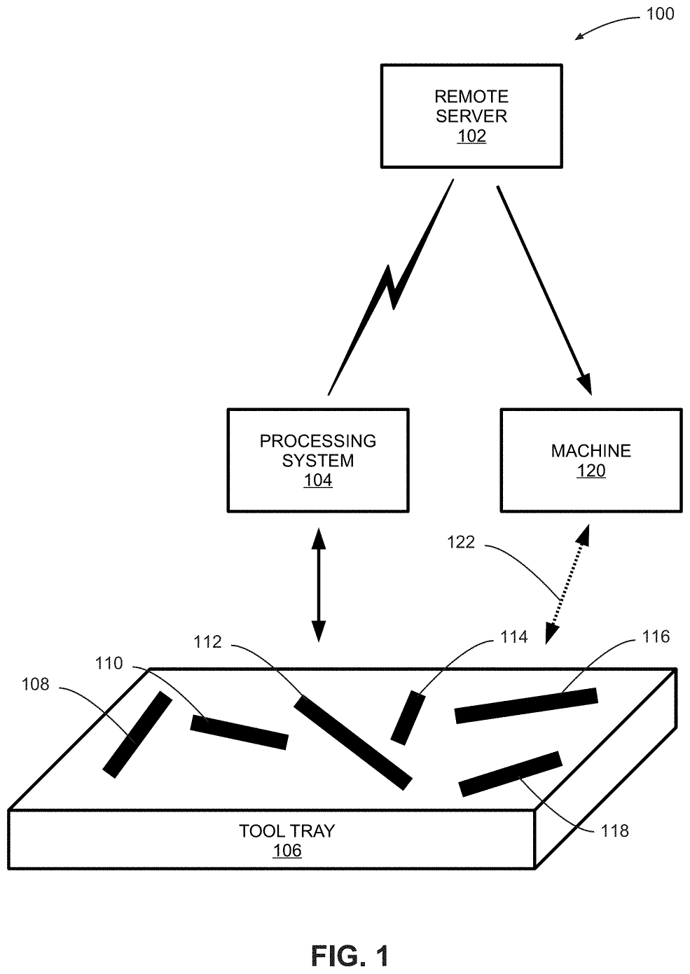

FIG. 1 is a block diagram depicting an embodiment of an intelligent tool detection system 100. In some embodiments, a tool tray 106 holds a plurality of tools such as a tool 108, a tool 110, a tool 112, a tool 114, a tool 116, and a tool 118. In particular embodiments, tool 108 through tool 118 comprise a tool set, and can be any combination of one or more drill bits, a pair of pliers, a wrench, a screwdriver, a punch, or any other metallic object. A machine 120 is associated with a process such as an assembly line or some other manufacturing process, with machine 120 being associated with a tool set that comprises tool 108 through tool 118. In some embodiments, machine 120 is enabled to remove a tool from tool tray 106 (i.e., select a tool from the tool set comprising tool 108 through tool 118), use the tool as a part of the process, and return the tool back to tool tray 106. A mechanical coupling 122 (depicted by a dashed line) denotes an ability of machine 120 to remove a tool from tool tray 106 and return the tool back to tool tray 106.

In some embodiments, tool tray 106 is configured to determine (i.e., detect) a removal of a tool from tool tray 106. In some embodiments, tool tray 106 uses inductive sensors to detect the removal. In particular embodiments, each tool in tool tray 106 is associated with a unique inductive sensor that is configured to detect the removal of that specific tool. Tool tray 106 is configured to communicate information associated with the removal of the tool to a processing system 104 via a communicative coupling. Processing system 104, in turn, is communicatively coupled to a remote server 102. In some embodiments, communication between processing system 104 and remote server 102 is accomplished via any combination of wired or wireless communication links including but not limited to Ethernet, TCP/IP, LVDS, I2C, Serial Peripheral Interface (SPI), a parallel port, Bluetooth, WiFi, 5G, WiMAX, Zigbee, digital I/O (including basic wired logic), HTTP (including HTTP using TCP/IP), or any other communication protocol. Processing system 104 communicates information associated with the removal of the tool as received from tool tray 106 to remote server 102.

In other embodiments, processing system 104 reads a data signal directly from one or more inductive sensors included in tool tray 106, where each inductive sensor outputs a first data signal when an associated tool is present in tool tray 106, and a second data signal when the tool has been removed from tool tray 106. Details about the inductive sensors are provided herein. In particular embodiments, each inductive sensor in tool tray 106 is associated with a unique tool, where the tool is placed in a vicinity of the corresponding inductive sensor (herein referred to as a “position” on tool tray 106). Processing system 104 analyzes the data signal received from the inductive sensor. If processing system 104 determines that the data signal received from the inductive sensor is the first data signal, then processing system 104 determines that the tool is present in tool tray 106. On the other hand, if processing system 104 determines that the data signal received from the inductive sensor is the second data signal, then processing system 104 determines that the tool has been removed from tool tray 106. Processing system 104 communicates information associated with the removal of the tool as received from tool tray 106 to remote server 102.

In some embodiments, remote server 102 is configured to determine whether machine 120 has removed an incorrect tool for the process. In such a case, remote server 102 may disable machine 120 and communicate an error to an operator of the machine. In particular embodiments, remote server 102 may record an event for time sequencing or set an alert in response to determining that machine 120 has removed an incorrect tool.

In some embodiments, machine 120 is an assembly line robot. In other embodiments, machine 120 is a torque tool, and tool 108 through tool 118 are any combination of drill bits and sockets. A function of intelligent tool detection system 100 is to ensure that an operator of machine 120 is using a correct tool (e.g., a correct drill bit or socket for a particular torque operation). As the operator goes through an assembly process, certain torque configurations are used which require a specific drill bit. This system is used to enable or disable, for example, a torque driver based on whether or not a correct drill bit or socket is being selected.

In some embodiments, tool tray 106 uses one or more inductive sensors to determine a removal of a tool from tool tray 106, as described in detail herein. In some embodiments, tool tray 106 detects a removal of a tool. In other embodiments, processing system 104 detects a removal of the tool. In particular embodiments, tool 108 through tool 118 are metallic tools, the presence of which can be detected using inductive coupling and inductive sensors. Other applications of intelligent tool detection system 100 include:

¼″ drive Bit Tray Systems (known as power bits) for use in error proofing manufacturing processes, where intelligent tool detection system 100 disables an associated machine, records an event for time sequencing, or sets an alert if an incorrect power bit is selected for a particular application.

Socket Tray Systems that use sockets instead of bits for use in error proofing manufacturing processes that employ sockets. These applications use similar detection disabling processes as described above for the power bits system.

Combination trays that may contain bits, sockets, or any other metallic device (such as wrenches, pliers, screwdrivers, etc.) for use in error proofing manufacturing processes.

Integration into workstations, end-effectors, and fixtures for presence detection of tools.

Workstation trays for tool presence identification (known as 5S, a series of principles that ensures clean and orderly work areas), where one or more workstation trays confirm that all the necessary tools are present for the workstation tasks.

Other applications in process control include implementing quality checks for a CNC machine, that includes providing a pass/fail diagnosis for each tool selected by a machine associated with the process flow. In some embodiments, a series of tools (e.g., calipers, a gauge, etc.), are sequentially picked out of a holder or a tray that has an architecture similar to that of tool tray 106. Every time a tool is picked up (i.e., removed from the tray) by a machine, this removal is transmitted by tool tray 106 to, for example, remote server 102 via processing system 104. If an incorrect tool is picked up (i.e., if a tool picked up is not consistent with a temporal sequence associated with a tool selection flow), the CNC machine (i.e., an example of machine 120) is disabled to prevent errors in the process flow.

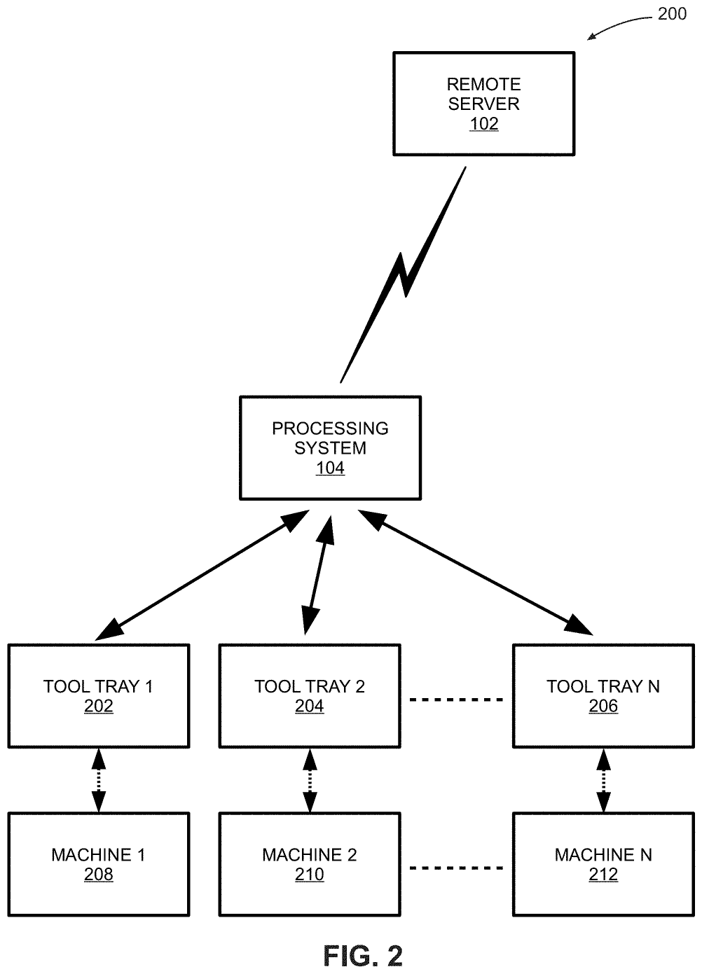

FIG. 2 is a block diagram depicting another embodiment of an intelligent tool detection system 200. In some embodiments, intelligent tool detection system 200 includes multiple tool trays—a tool tray 1 202, a tool tray 2 204, through a tool tray N 206. In some embodiments, each of tool tray 1 202, tool tray 2 204, through tool tray N 206 is configured to store a plurality of tools (i.e., a tool set), similar to tool tray 106. Each of tool tray 1 202, tool tray 2 204, through tool tray N 206 is respectively associated with a machine 1 208, a machine 2 210, through a machine N 212, where each of machine 1 208 through machine N 212 is configured to pick up a tool from a tool set associated with tool tray 1 202 through tool tray N 206 respectively, as a part of a process or a process flow (e.g., manufacturing). Each of tool tray 1 202 through tool tray N 206 is communicatively coupled to processing system 104 which, in turn, is communicatively coupled to remote server 102.

In some embodiments, each of tool tray 1 202 through tool tray N 206 is configured to determine (i.e., detect) a removal of a tool from tool tray 1 202 through tool tray N 206 respectively, by machine 1 208 through machine N 212 respectively. Each of tool tray 1 202 through tool tray N 206 is configured to communicate information associated with the removal of the respective tool to processing system 104. Processing system 104 communicates information associated with a removal of one or more tools as received from tool tray 1 202 through tool tray N 206, to remote server 102. In other embodiments, processing system 104 is configured to determine (i.e., detect) a removal of one or more tools from tool tray 1 202 through tool tray N 206 respectively, by machine 1 208 through machine N 212 respectively. Processing system 104 is configured to communicate information associated with the removal of the respective tools to remote server 102.

In some embodiments, remote server 102 is configured to determine whether any of machine 1 208 through machine N 212 has removed an incorrect tool for the respective process. In such a case, remote server 102 may disable any or all machines that have removed an incorrect tool, record an event for time sequencing, set an alert, and communicate an error to one or more operators of the machines.

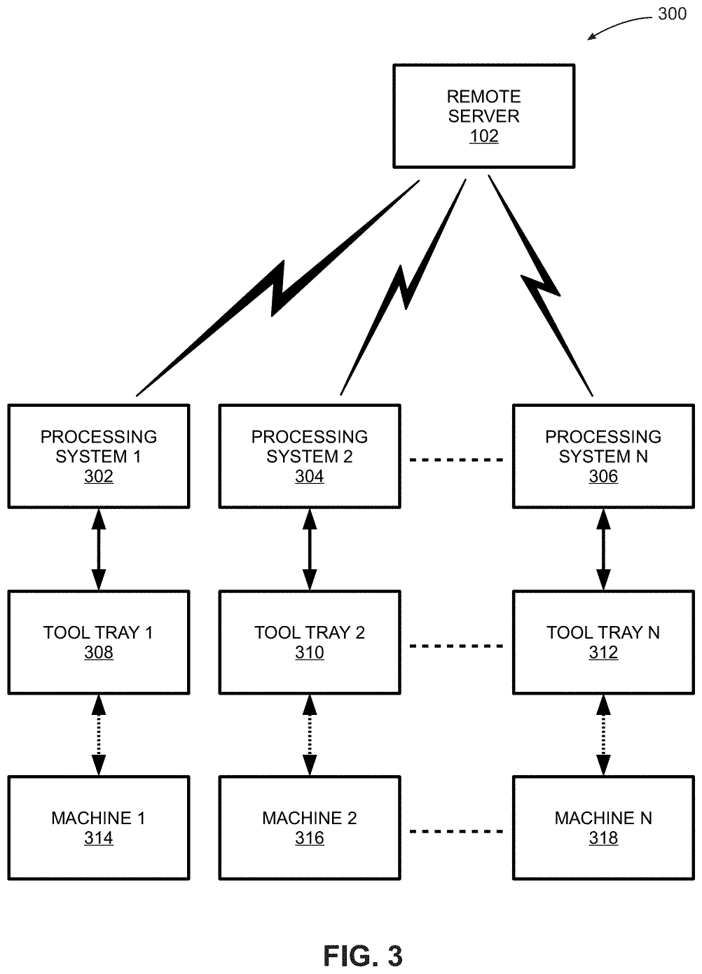

FIG. 3 is a block diagram depicting another embodiment of an intelligent tool detection system 300. In some embodiments, intelligent tool detection system 300 includes multiple tool trays—a tool tray 1 308, a tool tray 2 310, through a tool tray N 312. In some embodiments, each of tool tray 1 308, tool tray 2 310, through tool tray N 312 is configured to store a plurality of tools (i.e., a tool set), similar to tool tray 106. Each of tool tray 1 308, tool tray 2 310, through tool tray N 312 is respectively associated with a machine 1 314, a machine 2 316, through a machine N 318, where each of machine 1 314 through machine N 318 is configured to pick up a tool from tool tray 1 308 through tool tray N 312 respectively, as a part of a process or a process flow (e.g., manufacturing). Each of tool tray 1 308 through tool tray N 312 is, respectively, communicatively coupled to a processing system 1 302, a processing system 2 304, through a processing system N 306. In some embodiments, each of processing system 1 302 through processing system N 306 is communicatively coupled to remote server 102.

In some embodiments, each of tool tray 1 308 through tool tray N 312 is configured to determine (i.e., detect) a removal of a tool from tool tray 1 308 through tool tray N 312 respectively, by machine 1 314 through machine N 316 respectively. Each of tool tray 1 308 through tool tray N 312 is configured to communicate information associated with the removal of the respective tool to processing system 1 302 through processing system N 306 respectively. Each of processing system 1 302 through processing system N 306 communicates information associated with a removal of one or more tools as received from tool tray 1 308 through tool tray N 312, to remote server 102. In other embodiments, each of processing system 1 302 through processing system N 306 is configured to determine (i.e., detect) a removal of a tool from tool tray 1 308 through tool tray N 312 respectively, by machine 1 314 through machine N 316 respectively. Each of processing system 1 302 through processing system N 306 communicates information associated with a removal of a tool to remote server 102.

In some embodiments, remote server 102 is configured to determine whether any of machine 1 314 through machine N 318 has removed an incorrect tool for the process. In such a case, remote server 102 may disable any or all machines that have removed an incorrect tool, record an event for time sequencing, set an alert, and communicate an error to one or more operators of the machines.

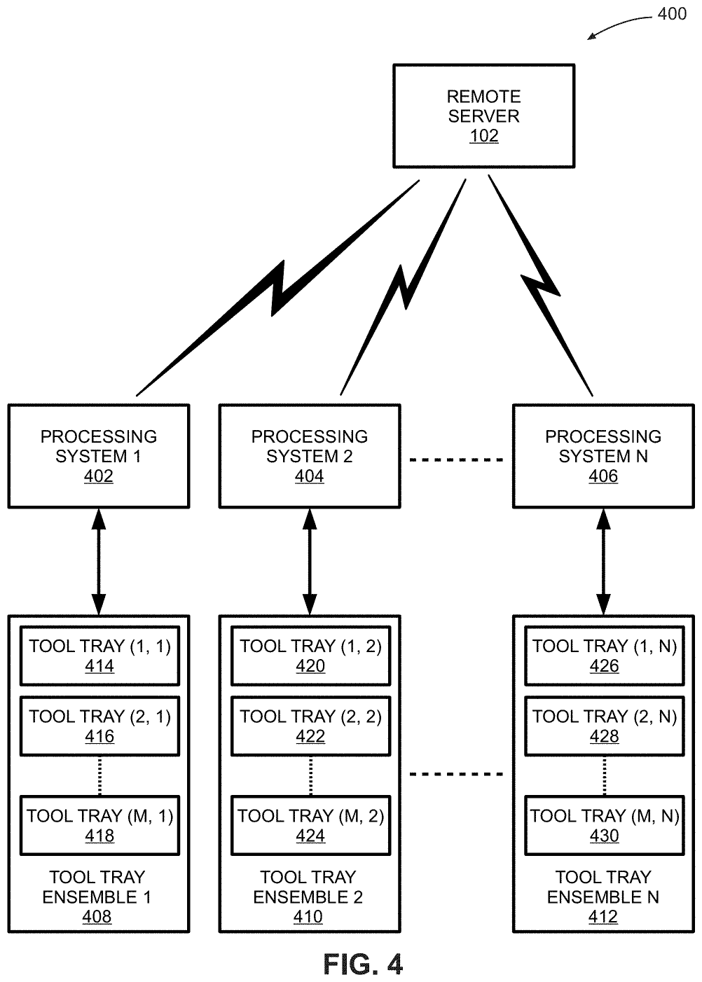

FIG. 4 is a block diagram depicting another embodiment of an intelligent tool detection system 400. In some embodiments, intelligent tool detection system 400 includes a tool tray ensemble 1 408, a tool tray ensemble 2 410, through a tool tray ensemble N 412. Each of tool tray ensemble 1 408, tool tray ensemble 2 410, through tool tray ensemble N 412 is respectively communicatively coupled with a processing system 1 402, a processing system 2 404, through a processing system N 406. Each of processing system 1 402 through processing system N 406 is communicatively coupled to remote server 102.

In some embodiments, tool tray ensemble 1 408 includes a plurality of tool trays—a tool tray (1, 1) 414, a tool tray (2, 1) 416 through a tool tray (M, 1) 418. Similarly, tool tray ensemble 2 410 includes a plurality of tool trays—a tool tray (1, 2) 420, a tool tray (2, 2) 422 through a tool tray (M, 2) 424, and so on, through tool tray ensemble N 412 including a plurality of tool trays—a tool tray (1, N) 426, a tool tray (2, N) 428 through a tool tray (M, N) 430.

Referring now to an operating process of tool tray ensemble 1 408, in some embodiments, each of tool tray (1,1) 414 through tool tray (M, 1) 418 is associated with a machine associated with a process (machines are not depicted in FIG. 4), and each of tool tray (1, 1) 414 through tool tray (M, 1) 418 is configured to hold a plurality of tools, in a manner similar to tool tray 106. In some embodiments, each of tool tray (1, 1) 414 through tool tray (M, 1) 418 is enabled to determine (i.e., detect) a removal of a tool from the respective tool tray by a machine. Each of tool tray (1, 1) 414 through tool tray (M, 1) 418 is configured to communicate information associated with the removal of the respective tool to processing system 1 402 via tool tray ensemble 1 408. Processing system 1 402 communicates information associated with a removal of one or more tools as received from tool tray ensemble 1 408 to remote server 102. In other embodiments, processing system 402 is configured to determine (i.e., detect) a removal of one or more tools from tool tray (1,1) 414 through tool tray (M, 1) 418 respectively, by a machine. Processing system 402 is configured to communicate information associated with the removal of the respective tools to remote server 102.

In some embodiments, remote server 102 is configured to determine whether any machine associated with tool tray (1, 1) 414 through tool tray (M, 1) 418 has removed an incorrect tool for the respective process. In such a case, remote server 102 may disable any or all machines that have removed an incorrect tool, record an event for time sequencing, set an alert, and communicate an error to one or more operators of the machines.

The above sequence of operations associated with tool tray ensemble 1 408 (and all included tool trays) can be extended to define operations associated with tool tray ensemble 2 410 through tool tray ensemble N 412, with remote server 102 being enabled to disable one or more machines that have removed an incorrect tool from one or more tool trays in tool tray ensemble 2 410 through tool tray ensemble N 412 in response to receiving associated information from processing system 1 402 through processing system N 406 respectively.

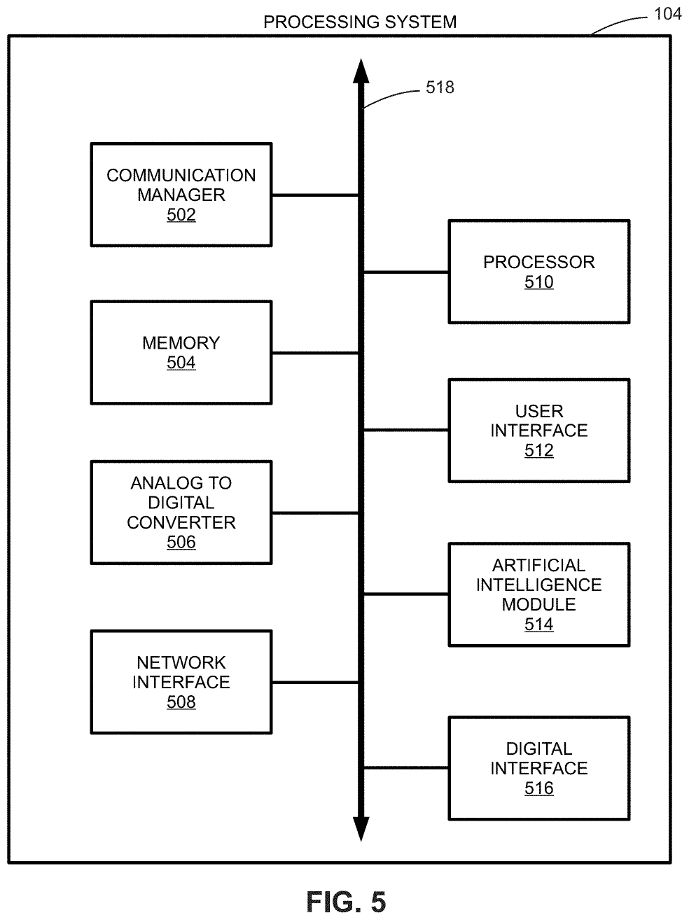

FIG. 5 is a block diagram depicting an embodiment of a processing system 104 that may be used to implement certain functions of intelligent tool detection system 100. In some embodiments, processing system 104 includes a communication manager 502 that is configured to manage communication protocols and associated communication with external peripheral devices as well as communication with other components in processing system 104. For example, communication manager 502 may be responsible for generating and maintaining the communication interface between processing system 104 and tool tray 106.

In some embodiments, processing system 104 includes a memory 504 that is configured to store data associated with operations of intelligent tool detection system 100. In particular embodiments, memory 504 includes both long-term memory and short-term memory. Memory 504 may be comprised of any combination of hard disk drives, flash memory, random access memory, read-only memory, solid state drives, and other memory components.

In some embodiments, processing system 104 includes an analog to digital converter 506 that converts analog signals generated by, for example, one or more inductive sensors associated with tool tray 106, into a digital format. Analog to digital converter 506 may generate digital data as multi-bit wide integer words in integer format. In some embodiments, analog to digital converter 506 generates 8-bit wide digital data. In other embodiments, analog to digital converter 506 generates 12-bit, 16-bit or 24-bit wide digital data. In some embodiments, digital data generated by analog to digital converter 506 is in twos complement format; in other embodiments, digital data generated by analog to digital converter 506 is in an unsigned binary format.

In embodiments, processing system 104 includes a network interface 508 that includes any combination of components that enable wired and wireless networking to be implemented. Network interface 508 may include an Ethernet interface, a WiFi interface, a Bluetooth interface, and so on. In some embodiments, network interface 508 enables processing system 104 to communicate with remote server 102 via, for example, a WiFi communication link.

Processing system 104 also includes a processor 510 configured to perform functions that may include generalized processing functions, arithmetic functions, and so on. Processor 510 is configured to process information associated with a removal of a tool from tool tray 106. Processor 510 may also perform functions such as initiating and maintaining communication with remote server 102.

In some embodiments, processing system 104 includes a user interface 512 that allows a user to interact with intelligent tool detection system 100. User interface 512 may include any combination of user interface devices such as a keyboard, a mouse, a trackball, one or more visual display monitors, touch screens, incandescent lamps, LED lamps, audio speakers, buzzers, microphones, push buttons, toggle switches, and so on.

Some embodiments of processing system 104 include an artificial intelligence module 514. Artificial intelligence module 514 is configured to implement machine learning algorithms associated with intelligent tool detection system 100 learning and implementing the tool detection operations described herein. For example, artificial intelligence module 514 may be associated with a learning and calibration process, where a user initiates or performs a calibration operation that allows artificial intelligence module 514 to learn how to detect a removal of a tool from a tool tray. Details of artificial intelligence module 514 are provided subsequently.

A digital interface 516 is included in some embodiments of processing system 104. In some embodiments, digital interface enables processing system 104 to interface with other digital systems using, for example, serial peripheral interface (SPI) communication links, inter-integrated circuit (I²C, or I2C) communication links, and so on. Other digital interfaces that may be implemented by digital interface 516 include parallel interfaces, serial interfaces, low voltage differential signaling (LVDS), and so on.

A data bus 218 included in some embodiments of processing system 104 is configured to communicatively couple the components associated with processing system 104 as described above.

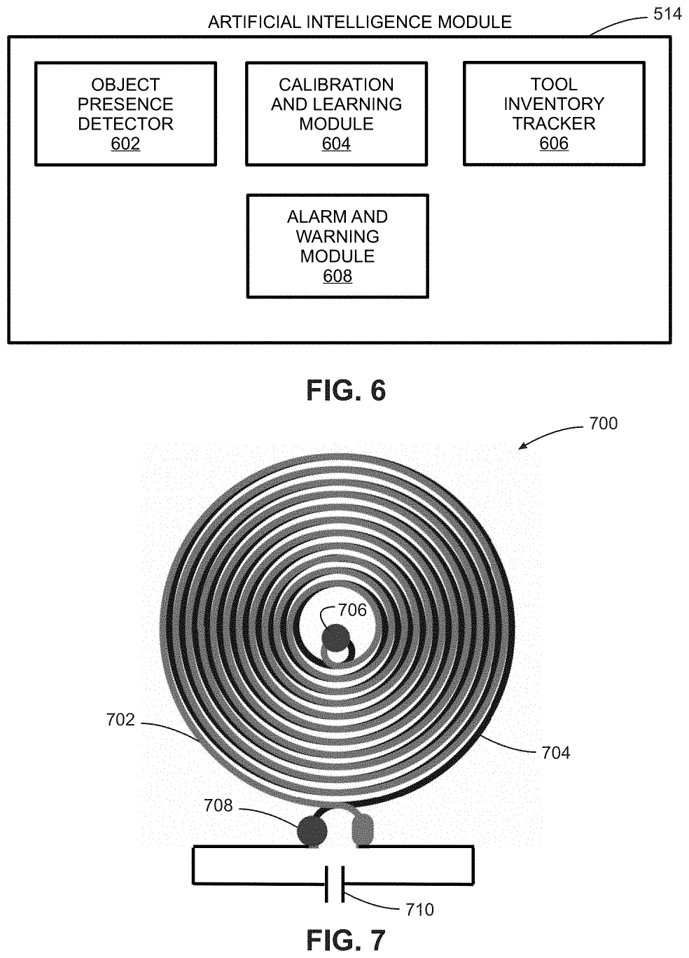

FIG. 6 is a block diagram depicting an embodiment of artificial intelligence module 514. In some embodiments, artificial intelligence module 514 includes an object presence detector 602 that is configured to detect a presence of an object (i.e., a tool) responsive to data received from tool tray 106. Object presence detector 602 is used by artificial intelligence module 514 as a basis for calibration and learning processes, as well as during autonomous operation to determine whether a tool has been removed from tool tray 106.

In some embodiments, artificial intelligence module 514 includes a calibration and learning module 604. Calibration and learning module 604 implements a machine learning (training) algorithm that interactively and iteratively trains artificial intelligence module 514 to detect a removal of a tool from tool tray 106. A tool inventory tracker 606 included in some embodiments of artificial intelligence module 514 enables artificial intelligence module 514 to track the plurality of tools (e.g., tool 108 through tool 118) contained in tool tray 106. Tool inventory tracker 606 is configured to determine whether a tool that was removed earlier has been replaced, or whether an incorrect tool has been selected (i.e., removed from tool tray 106).

An alarm and warning module 608 included in some embodiments of artificial intelligence module 514 is configured to generate one or more alarms and warnings if artificial intelligence module 514 detects that an incorrect tool has been removed. These alarms and warnings may be communicated to a user of the system using, for example, user interface 512, in the form of audio-visual alerts. For example, upon detecting that an incorrect tool has been removed, artificial intelligence module 514 may illuminate one or more LED lamps and sound one or more buzzers using user interface 512, to alert a user of the anomalous condition.

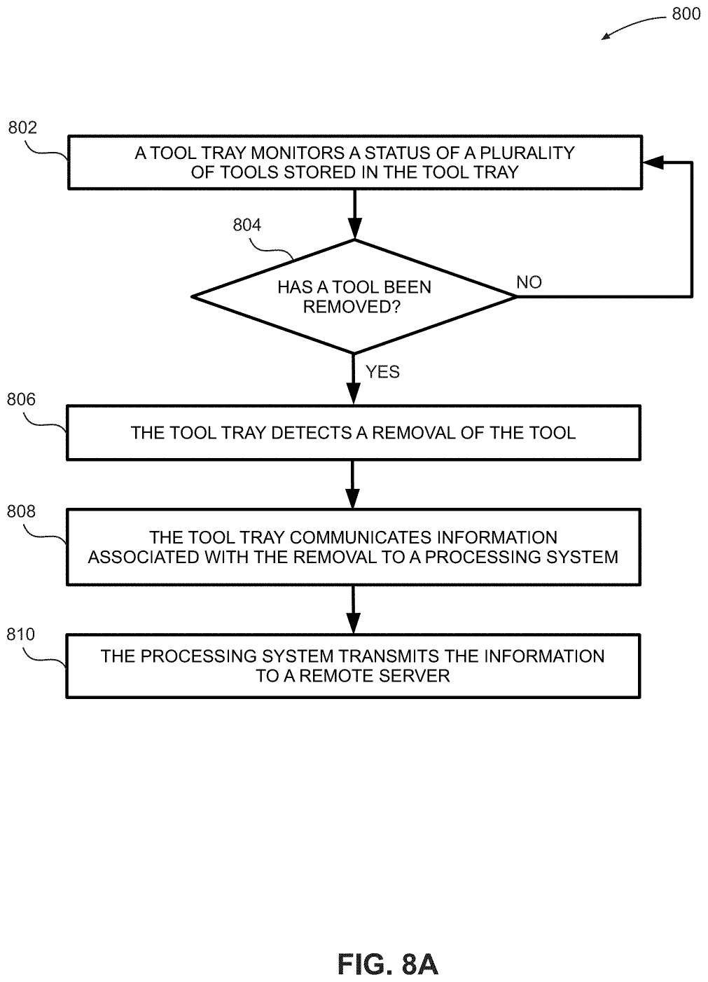

FIG. 7 is a schematic diagram depicting an embodiment of an inductive sensor 700. One or more inductive sensors such as inductive sensor 700 are used in embodiments of tool tray 106, to determine a removal of one or more tools from tool tray 106. In some embodiments, inductive sensor 700 is created from a PCB spiral trace, and is comprised of a copper coil on a first layer of PCB 702, and a copper coil on a second layer of PCB 704. In particular embodiments, copper coil on a first layer of PCB 702 and copper coil on a second layer of PCB 704 are electrically coupled using a via 706. Specifically, via 706 physically and electrically couples (i.e., joins) a first PCB layer associated with copper coil on a first layer of PCB 702 and a second PCB layer associated with copper coil on a second layer of PCB 704. Copper coil on a first PCB layer 702, via 706, and copper coil on a second PCB layer 704 comprise an inductance portion of inductive sensor 700. A capacitor 710 electrically coupled to this inductance portion using a via 708 comprises a capacitive portion of inductive sensor 700. Collectively, the inductive portion and capacitive portion constitute a resonant circuit (also referred to as an “LC resonant circuit”) that forms a basis for an operation of inductive sensor 700. FIG. 7 shows a circular PCB spiral trace used to realize the inductance portion of inductive sensor 700. In other embodiments, inductive sensor 700 may include a square-shaped PCB trace to realize the inductance portion of inductive sensor 700. In particular embodiments, this square-shaped PCB trace may itself spiral inward or outward. In still other embodiments, the PCB trace associated with inductive sensor may be triangular or have some other geometrical shape.

In some embodiments, inductive sensor 700 oscillates at a radio frequency (RF) resonant frequency in a range of 1 MHz to 10 MHz, depending on a selected design. This resonant frequency is a function of numerical values associated with the inductive portion and the capacitive portion of inductive sensor 700. In some embodiments, typical inductance values associated with the inductive portion are in a range of 1-10 microHenry, while typical capacitance values associated with the capacitive portion are 10-1000 picoFarad. As inductive sensor 700 resonates at the resonant frequency, inductive sensor 700 creates an electromagnetic field around it, in its proximity. If a tool (i.e., a metallic tool) is brought within this electromagnetic field (i.e., within a proximity of inductive sensor 700), the resonant frequency of the LC resonant circuit associated with inductive sensor 700 changes from the resonant frequency in an absence of the tool. In some embodiments, a tool present at a distance of less than 5 mm from the inductive sensor is sufficient to change the resonant frequency to a significant extent that this change can be detected. Sensing the associated changes in the resonant frequency of inductive sensor 700 in a presence or an absence of a tool, by either tool tray 106 or by processing system 104, allows intelligent tool detection system 100 to determine a removal of a tool from tool tray 106.

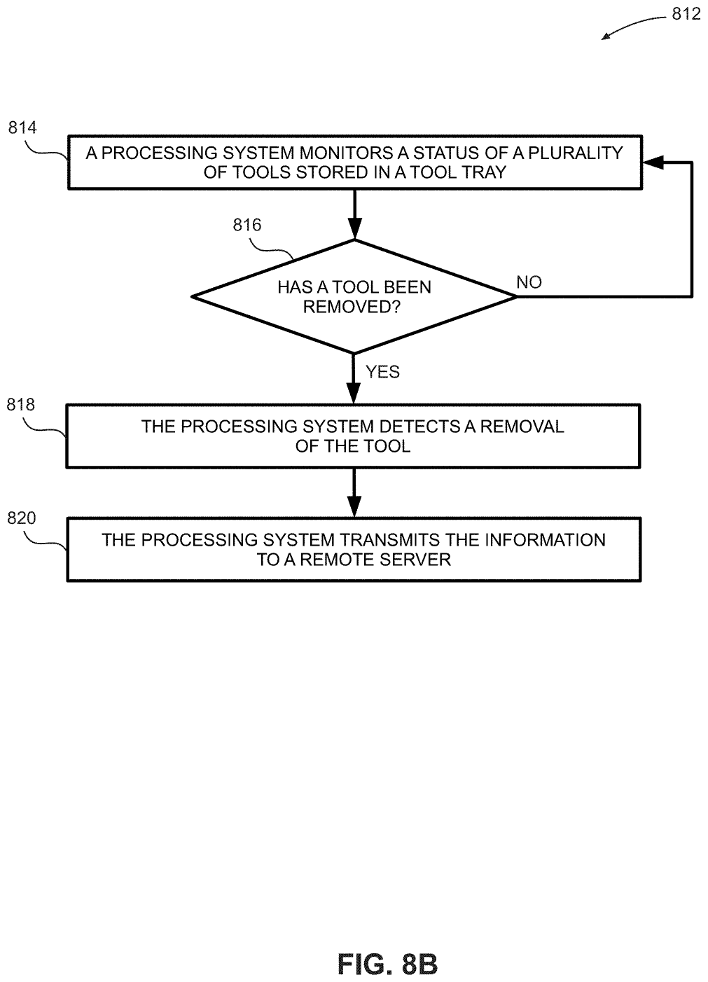

FIG. 8A is a flow diagram depicting an embodiment of a method 800 to detect a removal of a tool from a tool tray and transmit information associated with the removal to a remote server. At 800, a tool tray monitors a status of a plurality of tools stored in the tool tray. In some embodiments, the tool tray is tool tray 106 that includes a plurality of inductive sensors such as inductive sensor 700. In particular embodiments, the inductive sensors generate specific resonant frequencies that change from a nominal value once a tool is removed from a proximity of an inductive sensor. These resonant frequencies are sensed by one or more integrated circuits such as a Texas Instruments LDC0851 differential inductive switch that is electrically coupled to one or more inductive sensors.

At 804, the method checks to determine whether a tool has been removed from the tool tray. This determination is achieved by checking to see whether a resonant frequency associated with an inductive sensor (such as inductive sensor 700) has changed. If the resonant frequency has not changed, the method determines that a tool has not been removed from the tool tray. The method then returns to 802.

On the other hand if, at 804, the method determines that a the resonant frequency has changed, then the method determines that a tool has been removed from the tool tray. The method then goes to step 806, where the tool tray detects a removal of the tool. In some embodiments, this detection is performed by an integrated circuit such as a Texas Instruments LDC0851 that monitors one or more resonant frequencies corresponding to one or more inductive sensors. A removal of one or more tools will result in a change in the resonant frequencies of the inductive sensors associated with the tools.

In some embodiments, a change in a resonant frequency associated with an inductive sensor is detected by an integrated circuit and information associated with the detection (i.e., a change in the resonant frequency corresponding to a removal of a tool) is communicated by the tool tray (i.e., the integrated circuit in the tool tray) to a processing system such as processing system 104, at step 808. Finally, at 810, the processing system transmits the information associated with the removal to a remote server such as remote server 102.

FIG. 8B is a flow diagram depicting an embodiment of a method 812 to detect a removal of a tool from a tool tray and transmit information associated with the removal to a remote server. At 814, a processing system such as processing system 104 monitors a status of a plurality of tools stored in the tool tray. In some embodiments, the tool tray is tool tray 106 that includes a plurality of inductive sensors such as inductive sensor 700. In particular embodiments, the inductive sensors generate specific resonant frequencies that change from a nominal value once a tool is removed from a proximity of an inductive sensor. These resonant frequencies are sensed by one or more integrated circuits such as a Texas Instruments LDC1314 inductance to digital converter that is electrically coupled to the plurality of inductive sensors.

At 816, the method checks to determine whether a tool has been removed from the tool tray. This determination is achieved by checking to see whether a resonant frequency associated with an inductive sensor (such as inductive sensor 700) has changed. In some embodiments, this determination is performed by the processing system. If the resonant frequency has not changed, the method determines that a tool has not been removed from the tool tray. The method then returns to 814.

On the other hand if, at 816, the method determines that a the resonant frequency has changed, then the method determines that a tool has been removed from the tool tray. The method then goes to step 818, where the processing system detects a removal of the tool. In some embodiments, this detection is performed by the processing system, responsive to a condition that removal of one or more tools will result in a change in the resonant frequencies of the inductive sensors associated with the tools.

In some embodiments, a change in a resonant frequency associated with an inductive sensor is detected by the processing system, and information associated with the detection (i.e., a change in the resonant frequency corresponding to a removal of a tool) is communicated by the processing system to a remote server such as remote server 102, at step 820.

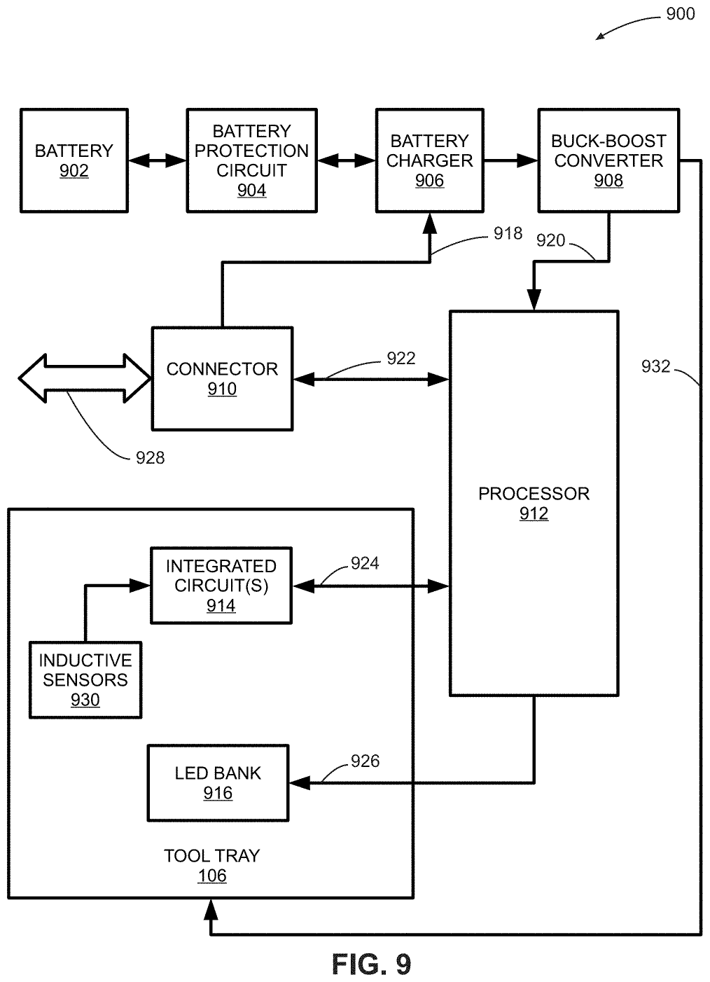

FIG. 9 is a block diagram depicting an embodiment of a circuit 900 used to implement an intelligent tool detection system. In some embodiments, circuit 900 includes a processor 912. In particular embodiments, processor 912 has a functionality similar to processing system 104. In some embodiments, processor 912 is a Particle Photon, and includes a wireless transceiver that allows processor 912 to communicate wirelessly over a wireless communication link such as Bluetooth, WiFi, and so on.

In some embodiments, a power supply for circuit 900 is provided by a battery 902. In particular embodiments, battery 902 is an 18650 lithium-ion battery. A battery protection circuit 904 prevents damage to battery 902 and other associated components, where such damage can be caused by occurrences such as short circuits or overcurrents. A battery charger 906 is used to charge battery 902 when the system is connected to an appropriate external charging power supply. In some embodiments, battery charger 906 is an MCP73833 device. Power from battery 902 is routed to processor 912 via a buck-boost converter 908 that provides a 3.3 Volt power supply 920 to processor 912. In some embodiments, buck-boost converter 908 is a TPS93001 device. Power supplied by buck-boost converter 908 is also used to power other components associated with circuit 900, such as LEDs and other integrated circuits on a PCB associated with circuit 900, as discussed subsequently. In some embodiments, circuit 900 includes a power switch (not shown in FIG. 9) that is used to switch circuit 900 on or off.

In some embodiments, tool tray 106 includes an inductive sensors 930 that includes one or more inductive sensors such as inductive sensor 700. Outputs from inductive sensors 930 are received by an integrated circuit(s) 914. In some embodiments, integrated circuit(s) 914 can be any combination of Texas Instruments LDC1314 and Texas instruments LDC0851 integrated circuits, the operation of which has been described herein. In particular embodiments, integrated circuit(s) 914 includes two integrated circuits, and inductive sensors 930 includes eight inductive sensors, with each integrated circuit being electrically coupled to four inductive sensors. In some embodiments, integrated circuit(s) 914 outputs data to processor 912 via an I2C communication link 924, where I2C communication link 924 is configured to transmit data using an inter-integrated circuit digital communication protocol. Processor 912 can also initialize and communicate with integrated circuit(s) using I2C communication link 924.

In some embodiments, processor 912 drives an LED bank 916 via a digital bus 926. In particular embodiments, LED bank 916 serves to communicate, for example, system status information to a user. Some embodiments may have LED bank 916 configured with 16 LED lamps. Information transmitted to LED bank 916 by processor 912 is an example of an output generated by user interface 512. In some embodiments, one or more LEDs included in LED bank 916 illuminate to show which tool an operator should use as well as which inductive sensor(s) associated with inductive sensors 930 are detecting a removal or replacement of corresponding tools. In some embodiments, processor 912 controls the LEDs included in LED bank 916 via an LED controller included in LED bank 916 using, for example, an I2C communication protocol. This LED controller is configured to control or toggle which LED should be on or off. LED bank 916 is also used to communicate with a user during calibration and learning processes associated with tool tray 106, as described herein. Furthermore, LED bank 916 can also be used to indicate to a user where to place a tool back in the tool tray once the tool has been removed.

In some embodiments, a connector 910 is configured to interface communicatively with other devices or external power sources via a coupling 928. In some embodiments, connector 910 is a USB-C connector. In some embodiments, external 5V power received from an external power source is routed via coupling 928 and connector 910, to battery charger 906 via a 5V power supply 918. This allows battery charger 906 to charge battery 902 using external power received via connector 910. Processor 912 can perform data communication (such as USB data communication) with other external devices via a USB data communication link 922, connector 910, and coupling 928.

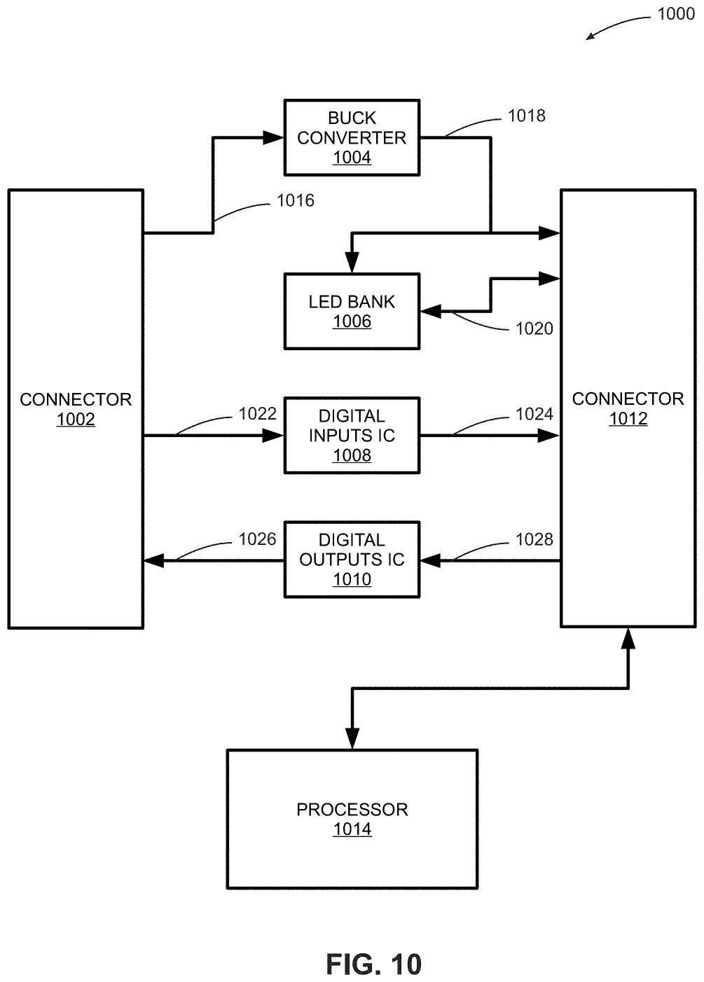

FIG. 10 is a block diagram depicting an embodiment of a circuit 1000 used to host a WiFi network. In some embodiments, circuit 1000 includes a processor 1014. In particular embodiments, processor 1014 is a Raspberry Pi 3B+. A buck converter 1004 converts a 24 Volt power supply 1016 received via a connector 1002 from a 24 Volt DC output wall AC-to-DC adapter (not shown in FIG. 10), to a 5 Volt power supply 1018. In some embodiments, buck converter 1004 is a LMR33630ADDAR device. In some embodiments, connector 1002 is a 20-way connector.

In some embodiments, 5 Volt power supply 1018 is routed to (i.e., supplies power to) an LED bank 1006, and to processor 1014 via a connector 1012. In some embodiments, connector 1012 is a 40-pin Raspberry Pi connector header. In embodiments, LED bank 1006 communicates with processor 1014 via connector 1012, using an I2C digital communication interface 1020.

In some embodiments, processor 1014 receives digital inputs via connector 1002. These digital inputs arrive at connector 1002, and are routed as a 24 Volt signal set 1022 to a digital inputs IC 1008. Digital inputs IC 1008 converts 24 Volt signal set 1022 to a digital 8X GPIO 1024, that is a set of 8 general purpose I/O signals at an appropriate voltage level for processor 1014. In some embodiments, this voltage level is 3.3 Volt. Digital 8X GPIO 1024 is routed to processor 1014 via connector 1012.

In some embodiments, processor 1014 generates digital outputs that are routed via connector 1012 as a digital 8X GPIO 1028. In particular embodiments, digital 8X GPIO 1028 is a set of 8 digital signals at a voltage level of 3.3 Volt. In some embodiments, digital 8X GPIO 1028 are received by a digital outputs IC 1010 that is configured to translate the 3.3 Volt digital 8X GPIO 1028 to a 24 Volt signal set 1026 that is output via connector 1002.

In some embodiments, circuit 1000 is referred to as a “controller interface.” On this controller interface, each of digital inputs IC 1008 and digital outputs IC 1010 functions as an input/output buffer, where each of digital inputs IC 1008 and digital outputs IC 1010 receives 8 discrete digital control signals and buffers them to the correct voltage at the output. For example, the output from the controller interface to a tool/machine goes from a 3.3V signal on the processor 1014, gets translated through digital outputs IC 1010 (functioning as an output IC/buffer) to a 24V control signal exposed at connector 1002. Similarly, the inputs to the controller interface are received at 24V at connector 1002, get translated down to 3.3V through digital inputs IC 1008 (functioning as a input IC/buffer circuit) and ultimately get passed to processor 1014 via connector 1012.

In some embodiments, connector 1002 is an industrial connector, and 24 Volt signal set 1022 and 24 Volt signal set 1026 are industrial digital signals for use in an industrial environment (e.g., manufacturing).

In some embodiments, circuit 1000 hosts a WiFi network that communicates with, for example, circuit 900 or any other embodiment of intelligent tool detection system 100. In some embodiments, circuit 900 may function as similarly to remote server 102. In some embodiments, intelligent tool detection system 100 sends tool removal detection signals to circuit 1000. In particular embodiments, other information exchanged between intelligent tool detection system 100 and circuit 1000 includes battery state of charge, firmware versions, and so on.

In some embodiments, LED bank 1006 is used to display status messages (e.g., an incorrect tool removed). 24 Volt signal set 1022 and 24 Volt signal set 1026 are used by circuit 1000 to communicate with, control, and possibly disable, one or more machines depending on whether an appropriate or incorrect tool selection status is received by circuit 1000 from intelligent tool detection system 100.

In some embodiments, intelligent tool detection system 100 communicates directly with circuit 1000 via a WiFi network. In other embodiments, intelligent tool detection system 100 and circuit 1000 communicate via a central router, using either wired or wireless connectivity. In this embodiment, intelligent tool detection system and circuit 1000 may be a part of a larger communications network (e.g., an intranet or a local area network). In embodiments, communication between intelligent tool detection system, circuit 1000, and remote server 102 may be achieved by using any variety of wireless and wired communication protocols such as Ethernet, WiFi, Bluetooth, 5G broadband, and so on. Different network topologies such as mesh and ring topologies may be used to interface multiple tool trays, as described herein.

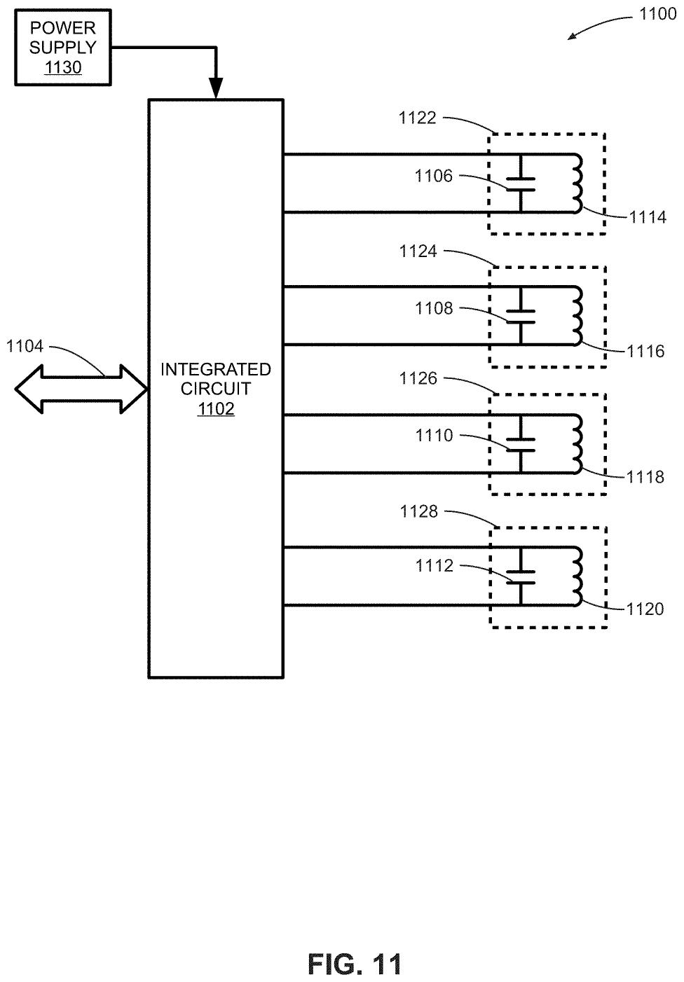

FIG. 11 is a block diagram depicting an embodiment of a circuit 1100 that includes multiple inductive sensors. FIG. 11 depicts an inductive sensor 1122, an inductive sensor 1124, an inductive sensor 1126, and an inductive sensor 1128. Each of inductive sensor 1122, inductive sensor 1124, inductive sensor 1126, and inductive sensor 1128 is comprised of a resonant circuit comprising an inductor 1114 and a capacitor 1106, a resonant circuit comprising an inductor 1116 and a capacitor 1108, a resonant circuit comprising an inductor 1118 and a capacitor 1110, and a resonant circuit comprising an inductor 1120 and a capacitor 1112, respectively. In some embodiments, each of capacitor 1106 through capacitor 1112 has a value of 1000 picoFarad, while each of inductor 1114 through inductor 1120 is a 0.2 mm PCB coil. Other embodiments may use an 8.5 mm PCB coil with an inductance value of 2 microHenry.

In some embodiments, each of inductive sensor 1122 through inductive sensor 1128 is electrically coupled to an integrated circuit 1102. In particular embodiments, integrated circuit 1102 is either of a Texas Instruments LDC1314 inductance to digital converter, or a Texas Instruments LDC0851 differential inductive switch. As shown in FIG. 11, integrated circuit 1102 can interface with four inductive sensors. This architecture is described in FIG. 9, where integrated circuit(s) 914 is comprised of two integrated circuits, and inductive sensors 930 is comprised of eight inductive sensors. In some embodiments, a Texas Instruments LDC1314 supports resonant frequencies associated with an inductive sensor that are in a range of 1 kHz to 10 MHz, while a Texas Instruments LDC0851 supports resonant frequencies associated with an inductive sensor from 1 kHz to 19 MHz. Accordingly, the eight inductive sensors can be designed to operate at any combination of resonant frequencies within a frequency range supported by integrated circuit 1102.

A power supply 1130 supplies 3.3 Volt power to integrated circuit 1102. Integrated circuit 1102 communicates with other digital devices such as processing system 104 or processor 912 using a digital interface 1104. In some embodiments, digital interface 1104 includes I2C communication links and general purpose I/O (GPIO) links.

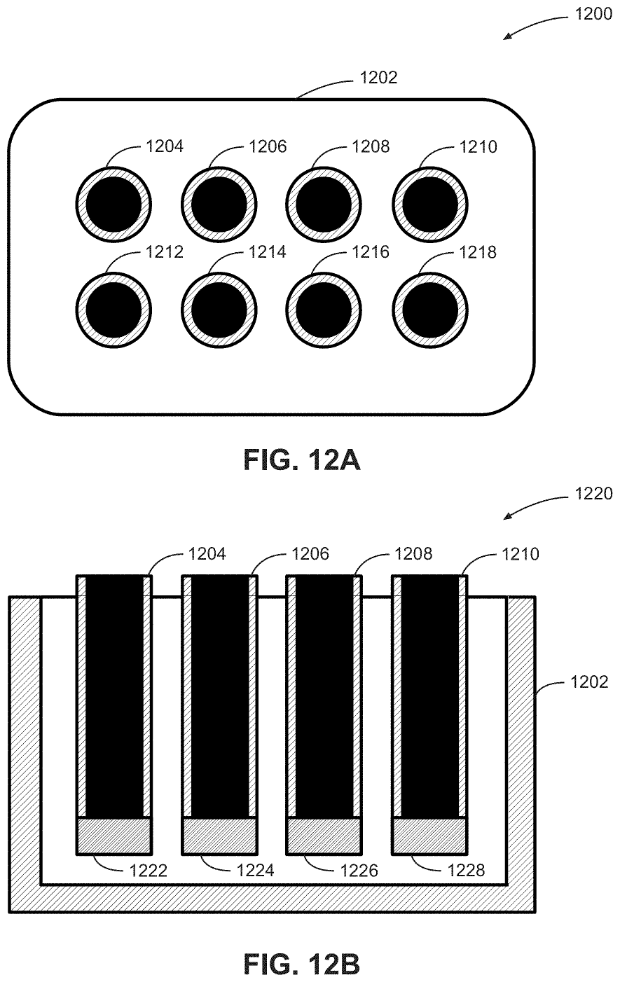

FIG. 12A is a schematic diagram depicting a top view 1200 of an embodiment of a tool tray 1202. Tool tray 1202 as depicted in FIG. 12A is a drill bit holder, and includes a receptacle 1204, a receptacle 1206, a receptacle 1208, a receptacle 1210, a receptacle 1212, a receptacle 1214, a receptacle 1216, and a receptacle 1218. Each of receptacle 1204 through receptacle 1218 is configured to store a drill bit. In some embodiments, each of receptacle 1204 through receptacle 1218 is configured to store a socket or some other tool with a cylindrical profile. Other embodiments of a tool tray may include specific areas, or positions, where one or more tools can be placed. Each position is in a proximity of an inductive sensor configured to detect a presence of a tool.

FIG. 12B is a schematic diagram depicting a cross-sectional side view 1220 of tool tray 1202. FIG. 12B depicts cross-sectional views of receptacle 1204, receptacle 1206, receptacle 1208, and receptacle 1210. An inductive sensor 1222 is physically located at a bottom end of receptacle 1204, as shown in FIG. 12B. Similarly, an inductive sensor 1224 is physically located at a bottom of receptacle 1206, an inductive sensor 1226 is physically located at a bottom of receptacle 1208, and an inductive sensor 1228 is physically located at a bottom of receptacle 1210.

FIG. 12C is a schematic diagram depicting a cross-sectional side view 1230 of a tool tray 1202 with a drill bit 1232. FIG. 12C depicts receptacle 1204 through receptacle 1210, with inductive sensor 1222 through inductive sensor 1228, as described in FIG. 12B. When drill bit 1232 is present in receptacle 1204, drill bit 1232 affects an electromagnetic field generated by inductive sensor 1222 and changes an associated resonant frequency associated with inductive sensor 1222. This change is used to detect a presence of drill bit 1232. When drill bit 1232 is removed, the resonant frequency associated with inductive sensor 1222 returns back to its default value corresponding to an LC resonant circuit associated with inductive sensor 1222. This resonant frequency reverting back to its default value is used to determine a removal of drill bit 1232.

During an assembly workflow if drill bit 1232 is removed by a machine, this removal can be detected and processed using inductive sensor 1222, a processing system such as processing system 104, and remote server 102. If drill bit 1232 is removed at an incorrect time during the workflow, remote server 102 can disable the associated machine and issue a warning to an operator. In particular embodiments, remote server 102 is configured to record an event for time sequencing, or set an alert in response to drill bit 1232 being removed at an incorrect time during the workflow.

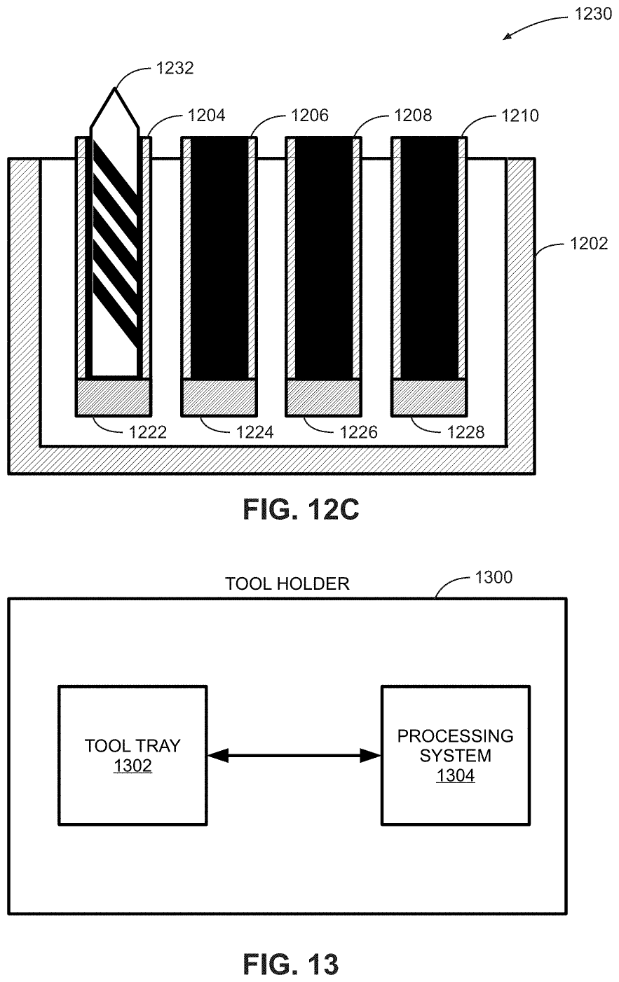

FIG. 13 is a block diagram depicting an embodiment of a tool holder 1300. In some embodiments, tool holder 1300 is a composite assembly comprised of a tool tray 1302 and a processing system 1304. Rather than being standalone, separate components, tool tray 1302 and processing system 1304 are housed in a common housing to form tool holder 1302. In some embodiments, tool holder 1302 can hold one or more tools, detect a removal of the one or more tools during a workflow, and transmit information associated with the removal to a remote server. In other words, tool holder 1302 performs the functions of intelligent tool detection system 100 excluding remote server 102.

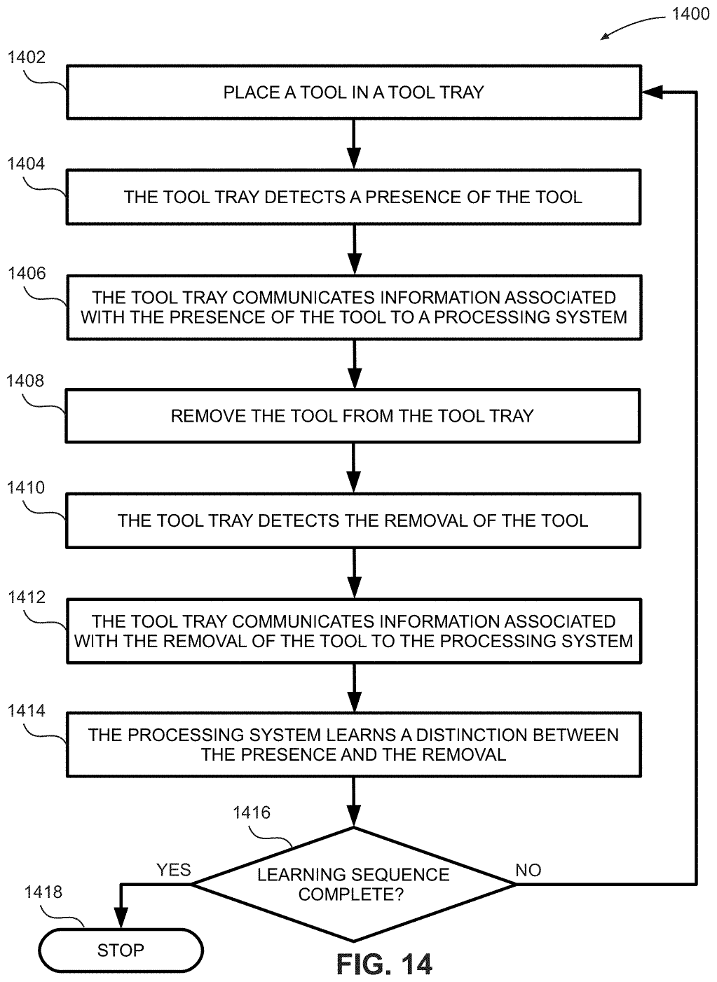

FIG. 14 is a flow diagram depicting an embodiment of a method 1400 used to implement a learning sequence. Some embodiments of intelligent tool detection system 100 implement a learning (or training) sequence that allows processing system 104 to learn a distinction between a tool being present in tool tray 106 and a tool being removed from tool tray 106. In some embodiments, the learning sequence is implemented by artificial intelligence module 514.

At 1402, a tool is placed in a tool tray. In some embodiments, this placement may be performed by a user. In other embodiments, this placement may be performed by a robot or any other automated system. At 1404, the tool tray detects a presence of the tool. In some embodiments, the placement of the tool in the tool tray by the user affects an RF electromagnetic field generated by one or more inductive sensors, as discussed previously. This causes a change in a resonant frequency of a resonant LC circuit associated with the inductive sensor. In some embodiments, this change is detected by the tool tray. In other embodiments, this change is detected by a processing system, as described herein.

At 1406, the tool tray communicates information associated with the presence of the tool to a processing system. Next, at 1408, the tool is removed from the tool tray. In some embodiments, this removal may be performed by a user. In other embodiments, this removal may be performed by a robot or any other automated system. This removal results in the resonant frequency of the inductive sensor returning back to its default value. At 1410, this change is detected by the tool tray. In other embodiments, this change is detected by the processing system. At 1412, the tool tray communicates information associated with the removal of the tool to the processing system. Next, at 1414, the processing system learns a distinction between the presence of the tool and the removal of the tool, responsive to a detection in the changes in the resonant frequency. In some embodiments, information associated with the learning is stored by the processing system in nonvolatile memory (NVM). This allows the processing system to retain this learned information through multiple on/off power cycles.

At 1416, the method checks to determine whether the learning sequence is complete. In some embodiments, the learning sequence may entail a user performing the tool placement and removal sequence several times (e.g., 4 times or 7 times). Performing the tool placement and removal sequence several times reinforces a learning process associated with the learning sequence for the processing system. If the learning sequence is not complete and more iterations are needed, the method returns back to 1402. If the learning sequence is complete, then the method goes to 1418, where the method terminates.

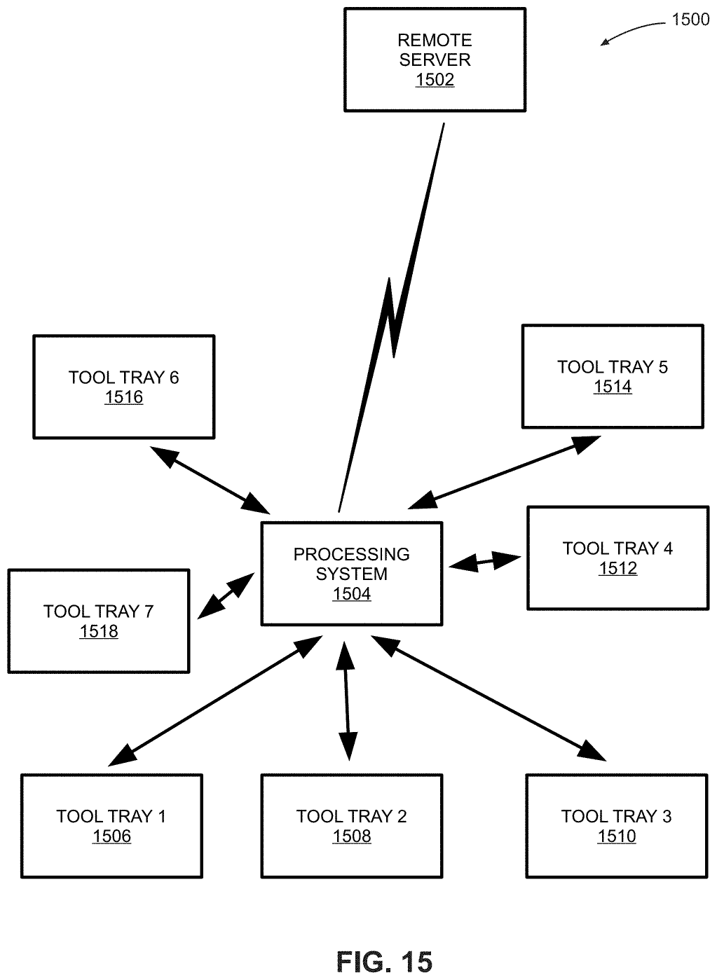

FIG. 15 is a block diagram depicting an embodiment of a star topology 1500. In some embodiments, star topology 1500 includes a plurality of tool trays—a tool tray 1 1506, a tool tray 2 1508, a tool tray 3 1510, a tool tray 4 1512, a tool tray 5 1514, a tool tray 6 1516, and a tool tray 7 1518, where tool tray 1 1506 through tool tray 7 1518 are individually bidirectionally communicatively coupled with a processing system 1504 using any combination of wired or wireless communication links including but not limited to Ethernet, TCP/IP, LVDS, I2C, Serial Peripheral Interface (SPI), a parallel port, Bluetooth, WiFi, 5G, WiMAX, Zigbee, digital I/O (including basic wired logic), HTTP (including HTTP using TCP/IP), or any other communication protocol.

In some embodiments, processing system 1504 is communicatively coupled to a remote server 1502 via a wired or wireless communication links including but not limited to Ethernet, TCP/IP, LVDS, I2C, Serial Peripheral Interface (SPI), a parallel port, Bluetooth, WiFi, 5G, WiMAX, Zigbee, digital I/O (including basic wired logic), HTTP (including HTTP using TCP/IP), or any other communication protocol.

In some embodiments, each of tool tray 1 1506 through tool tray 7 1518 is configured with a plurality of inductive sensors, as described herein. Using these inductive sensors, each of tool tray 1 1506 through tool tray 7 1518 is configured to monitor a status of one or more tools respectively contained in tool tray 1 1506 through tool tray 7 1518, and to detect whether one or more tools have been removed. If a tool has been removed, then the respective tool tray communicates information related to the removal to processing system 1504 which, in turn, communicates this information to remote server 1502.

In other embodiments, processing system 1504 is configured to detect whether a tool has been removed from any or more of tool tray 1 1506 through tool tray 7 1518. In these embodiments, processing system 1504 communicates information associated with the respective removal to remote server 1502.

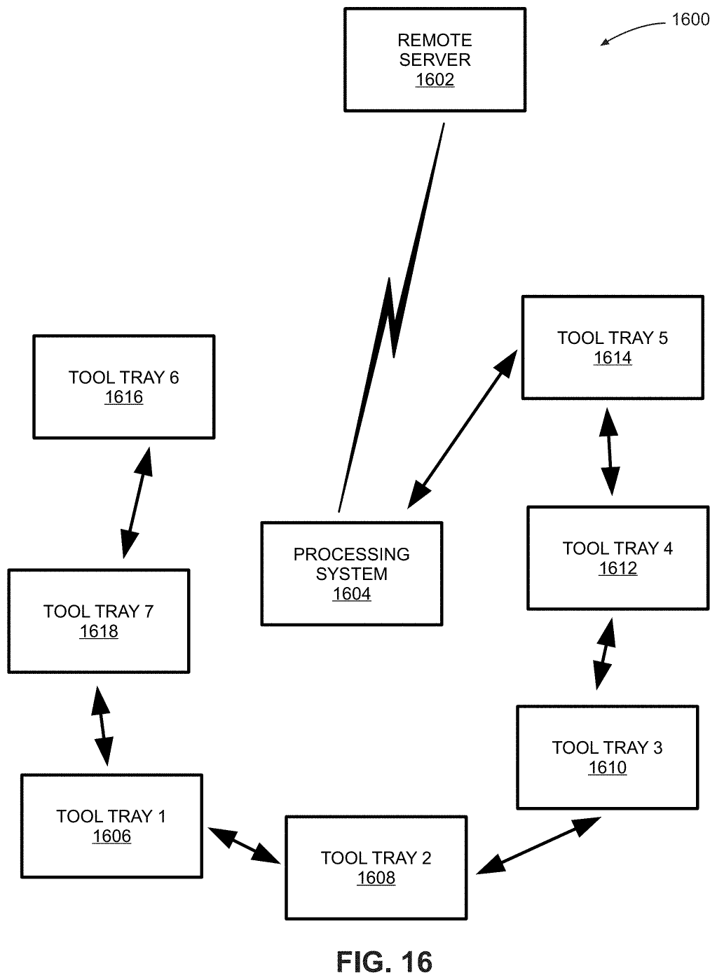

FIG. 16 is a block diagram depicting an embodiment of a ring topology 1600. In some embodiments, ring topology 1600 includes a plurality of tool trays—a tool tray 1 1606, a tool tray 2 1608, a tool tray 3 1610, a tool tray 4 1612, a tool tray 5 1614, a tool tray 6 1616, and a tool tray 7 1618, where tool tray 1 1606 through tool tray 7 1618 are communicatively coupled in a ring topology. Specifically, tool tray 6 1616 is communicatively coupled to tool tray 7 1618; tool tray 7 1618 is communicatively coupled to tool tray 1 1606 and to tool tray 6 1616; tool tray 1 1606 is communicatively coupled to tool tray 2 1608 and to tool tray 7 1618; tool tray 2 1608 is communicatively coupled to tool tray 1 1606 and to tool tray 3 1610; tool tray 3 is communicatively coupled to tool tray 4 1612 and to tool tray 2 1608; tool tray 4 1612 is communicatively coupled to tool tray 5 1614 and to tool tray 3 1610; and tool tray 5 1614 is communicatively coupled to processing system 1604 and to tool tray 4 1612. Each of the communication links in FIG. 16 is a bidirectional communication link that can be realized using any combination of wired or wireless communication links including but not limited to Ethernet, TCP/IP, LVDS, I2C, Serial Peripheral Interface (SPI), a parallel port, Bluetooth, WiFi, 5G, WiMAX, Zigbee, digital I/O (including basic wired logic), HTTP (including HTTP using TCP/IP), or any other communication protocol.

In some embodiments, processing system 1604 is communicatively coupled to a remote server 1602 via a wired or wireless communication links including but not limited to Ethernet, TCP/IP, LVDS, I2C, Serial Peripheral Interface (SPI), a parallel port, Bluetooth, WiFi, 5G, WiMAX, Zigbee, digital I/O (including basic wired logic), HTTP (including HTTP using TCP/IP), or any other communication protocol.

In some embodiments, each of tool tray 1 1606 through tool tray 7 1618 is configured with a plurality of inductive sensors, as described herein. Using these inductive sensors, each of tool tray 1 1606 through tool tray 7 1618 is configured to monitor a status of one or more tools respectively contained in tool tray 1 1606 through tool tray 7 1618, and to detect whether one or more tools have been removed. If a tool has been removed, then the respective tool tray communicates information related to the removal to processing system 1604 via a chained communication protocol as described below. Processing system 1604 then transmits any information associated with a tool removal to remote server 1602.

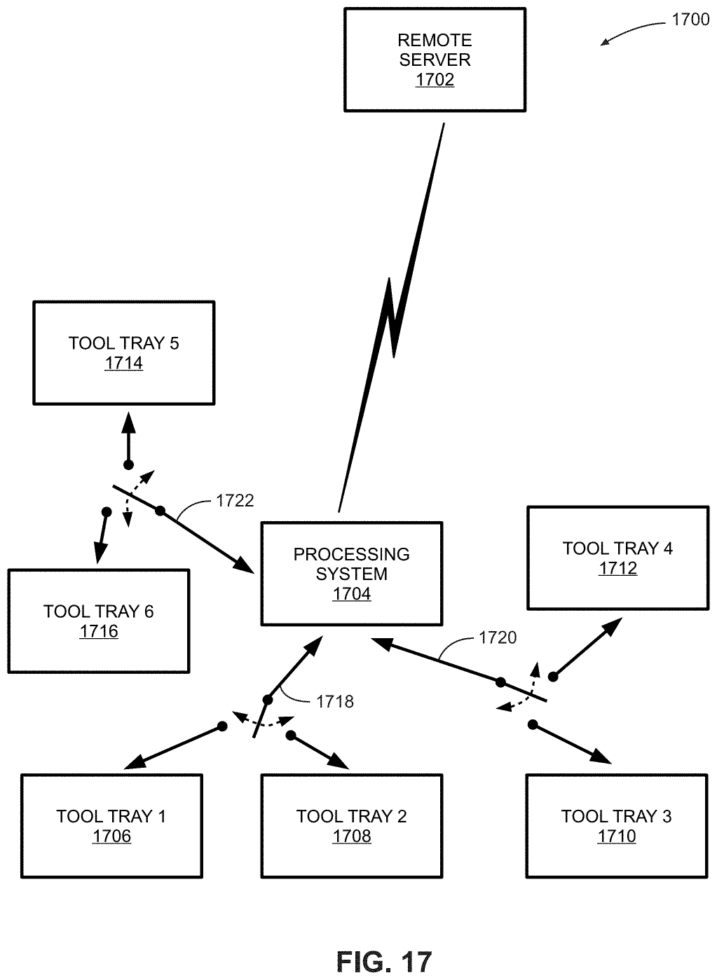

The ring topology depicted in FIG. 17 allows a tool tray to communicate with processing system 1604 via a data hopping communication chain that includes zero to five tool trays other than the tool tray that wishes to communicate with processing system 1604. For example, if tool tray 2 1608 wishes to send information associated with a tool removal to processing system 1604, tool tray 2 1608 first transmits this information to tool tray 3 1610 which relays this information to tool tray 4 1612, which further relays this information to tool tray 5 1614, which transmits the information to processing system 1604. A similar data hopping communication chain is followed for data transfer between processing system 1604 and any of tool tray 1 1606 through tool tray 7 1618.

FIG. 17 is a block diagram depicting an embodiment of an intelligent tool detection system 1700 with a switching functionality. In some embodiments, intelligent tool detection system 1700 includes a processing system 1704 communicatively coupled to a remote server 1702 via, for example, a WiFi communication link. A plurality of tool trays—a tool tray 1 1706, a tool tray 2 1708, a tool tray 3 1710, a tool tray 4 1712, a tool tray 5 1714, and a tool tray 6 1716 are communicatively coupled with processing system 1704 using multiplexed communication links. Specifically, tool tray 1 1706 and tool tray 2 1708 are communicatively coupled with processing system 1704 using a multiplexed communication link 1718 that presents a topology of a mesh network. Multiplexed communication link 1718 allows either tool tray 1 1706 or tool tray 2 1708 to communicate with processing system 1704, using a switched (multiplexing) arrangement as depicted in FIG. 17. Similarly, tray 3 1710 and tool tray 4 1712 are communicatively coupled with processing system 1704 using a multiplexed communication link 1720, and tray 5 1714 and tool tray 6 1716 are communicatively coupled with processing system 1704 using a multiplexed communication link 1722. Each of the multiplexed communication links in FIG. 17 is a bidirectional communication link that can be realized using any combination of wired or wireless communication links including but not limited to Ethernet, TCP/IP, LVDS, I2C, Serial Peripheral Interface (SPI), a parallel port, Bluetooth, WiFi, 5G, WiMAX, ZigBee, or any other communication protocol. This switching functionality associated with intelligent tool detection system 1700 reduces the number of communication links as compared to, for example, star topology 1500.

In some embodiments, each of tool tray 1 1706 through tool tray 6 1716 is configured with a plurality of inductive sensors, as described herein. Using these inductive sensors, each of tool tray 1 1706 through tool tray 6 1716 is configured to monitor a status of one or more tools respectively contained in tool tray 1 1706 through tool tray 6 1716, and to detect whether one or more tools have been removed. If a tool has been removed, then the respective tool tray communicates information related to the removal to processing system 1704 using an associated multiplexed communication link, which, in turn, communicates this information to remote server 1702.

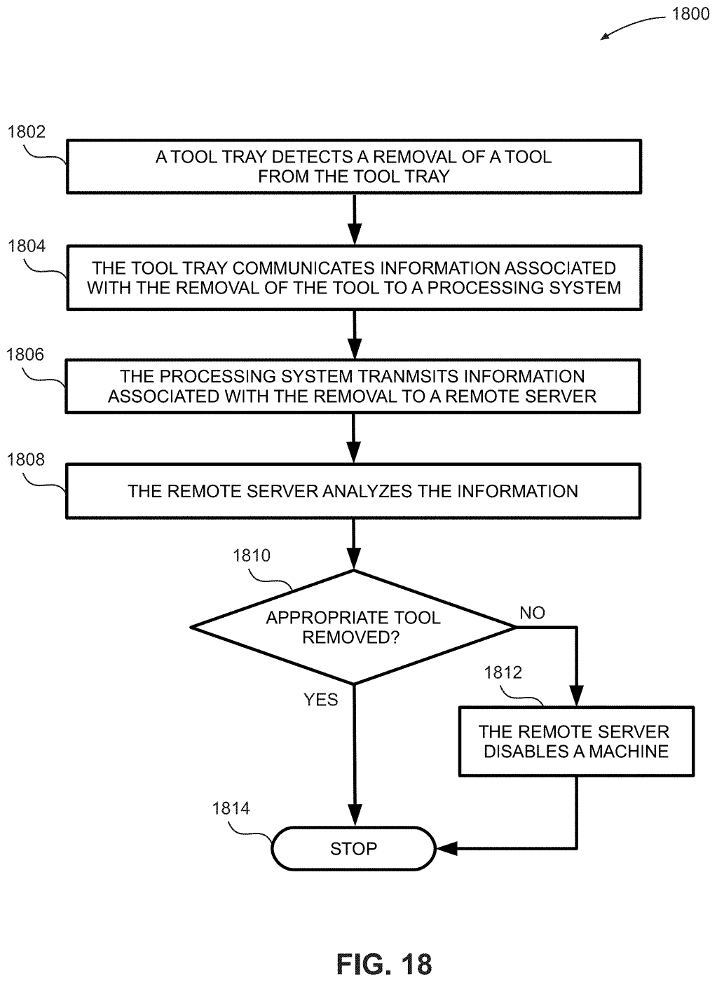

FIG. 18 is a block diagram depicting an embodiment of a method 1800 to disable a machine. At 1802, a tool tray such as tool tray 106 detects a removal of a tool from the tool tray using, for example, one or more inductive sensors as described herein. At 1804, the method communicates information associated with the removal of the tool to a processing system such as processing system 104. In other embodiments, the processing system directly detects the removal of the tool, as described herein.

At 1806, the processing system transmits information associated with the removal to a remote server such as remote server 102. Next, at 1808, the remote server analyzes the information. At 1810, the method checks to determine whether an appropriate tool is removed for an associated process such as a manufacturing process. In some embodiments, this check is performed by the remote server. In particular embodiments, the remote server also determines a type of the tool that has been removed (e.g., a wrench, a pair of pliers, a drill bit, and so on). This determination is performed based on the remote server having prior knowledge of where a specific tool is placed in the tool tray after a user performs a training and calibration process such as method 1400. For example, a wrench is typically placed at the center of the tool tray and this placement is known to the remote server, and if the inductive sensor at the center of the tool tray indicates that the corresponding tool has been removed, then the remote server uses previously learned knowledge to infer that the wrench has been removed. If an appropriate tool is removed, then the method terminates at 1814. If an appropriate tool is not removed, then the method goes to 1812, where the remote server disables a machine associated with the tool and the process. In some embodiments, the method also records an event for time sequencing or sets an alert at 1812. The method then terminates at 1814.

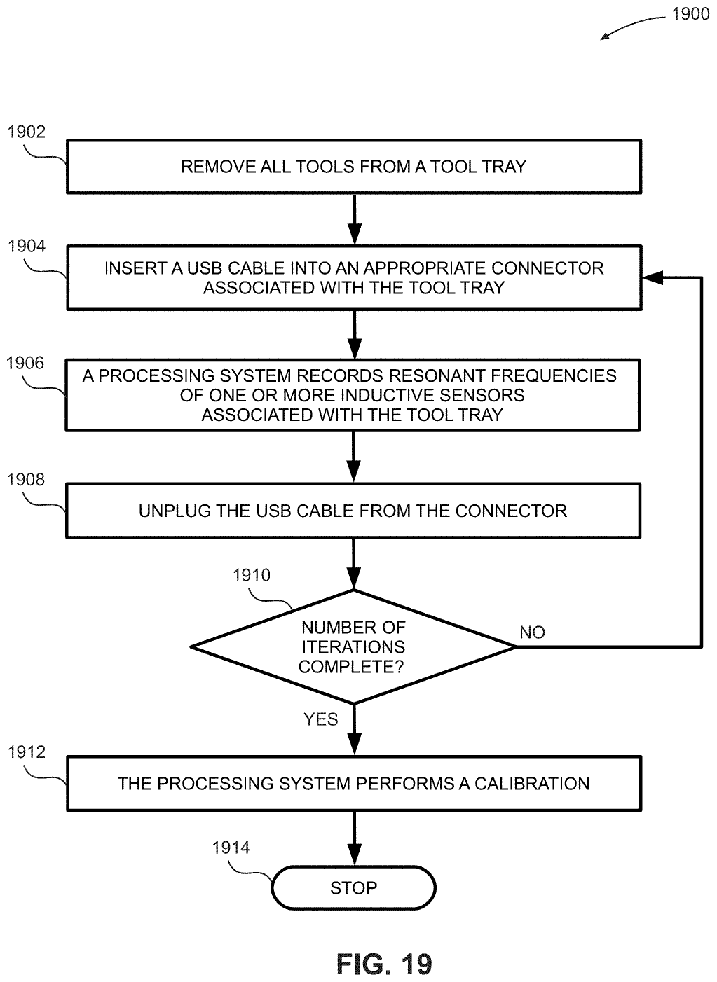

FIG. 19 is a flow diagram depicting an embodiment of a method 1900 to calibrate an intelligent tool detection system. At 1902, a user removes all tools from a tool tray such as tool tray 106. Next, at 1904, the user inserts a USB cable into an appropriate connector associated with the tool tray. In some embodiments, the connector is similar to connector 910. At 1906, a processing system similar to processing system 104 records resonant frequencies of one or more inductive sensors associated with the tool tray. This process allows the processing system to establish a baseline (i.e., a nominal) resonant frequency for each inductive sensor corresponding to no tools being present in the tool tray. Each of these nominal resonant frequencies will allow the processing system to determine whether a tool has been removed from a particular position in the tool tray during normal usage, or detect a change in the resonant frequency when a tool is placed in a specific position. The processing system enters a mode of recording the resonant frequencies responsive to the user plugging in the USB cable into the connector. At 1908, the user unplugs the USB cable from the connector. This causes the processing system to exit the mode of recording the resonant frequencies. At 1910, the method checks to determine whether a certain number of iterations corresponding to the user plugging in and unplugging the USB cable is complete. In some embodiments, this number of iterations ranges from 2 to 5. If the number of iterations is not complete, the method returns back to 1904, where the user goes through a next round of plugging in and unplugging the USB cable. On the other hand if, at 1910, the method determines that the number of iterations is complete, then the method goes to 1912, where the processing system performs a calibration. During the calibration, the processing system identifies a nominal resonant frequency associated with each inductive sensor in the tool tray. This nominal resonant frequency corresponds to no tool being present in the position corresponding to the inductive sensor. Then during normal use, when a user places a tool in a particular position, a change in the resonant frequency of the associated inductive sensor is used to detect a presence of the tool. Finally, the method terminates (i.e., stops) at 1914. Using a number of iterations (e.g., 2 to 5) allows the processing system to reinforce the frequency values associated with the inductive sensors.

In some embodiments, the processing system uses software to detect an insertion or removal of the USB cable. Once a user has inserted and removed the USB cable a number of times equal to the number of iterations and leaves the USB cable disconnected, the processing system initiates a special LED sequence to inform the user that a calibration is being performed by the processing system (i.e., at step 1912); the sequence of inserting and removing the USB cable itself triggers the processing system to initiate the calibration process. Once the LED sequence is complete, the user knows that the calibration is complete and they can continue to use the tool tray as they wish.

In some embodiments, method 1900 is used during an initial manufacturing process of a tool tray, and perhaps later due to sensor drift, or an erratic or noisy sensor (i.e., if an end user notices that one or more sensors associated with the tool tray are not functioning properly). In the latter case, it is essential to recalibrate the sensor values to determine one or more resonant frequencies associated with one or more inductive sensors included in the tool tray, without a tool being present in any of the positions.

The description above presents a user performing the workflow associated with method 1900. In other embodiments, this workflow may instead be performed by an automated system such as a robotic actuator or some other kind of automated tool manipulation system.

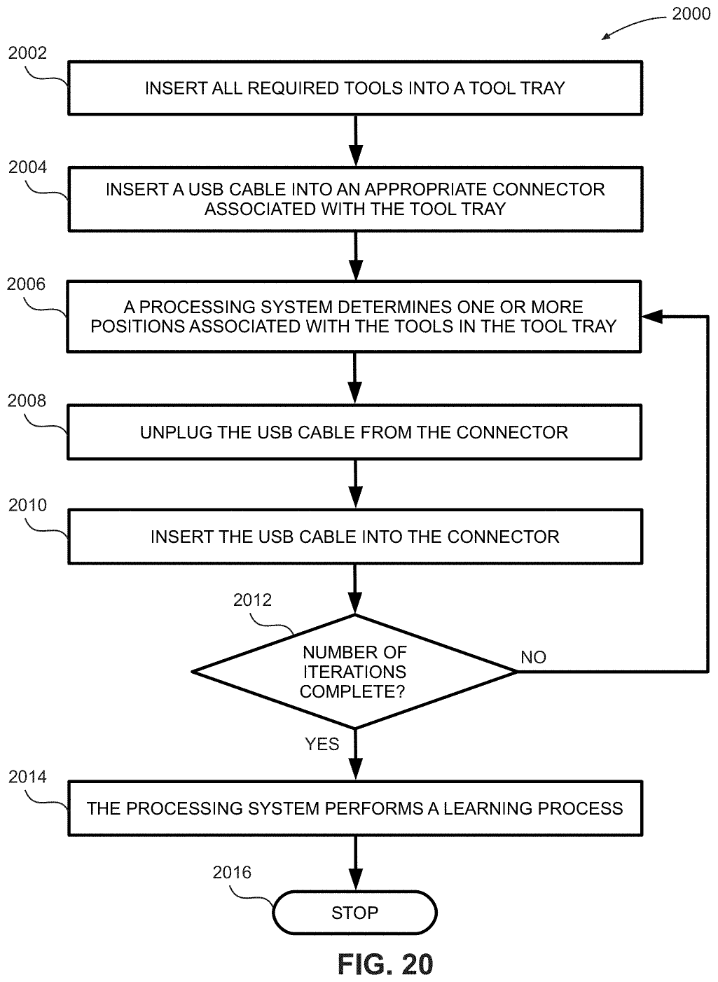

FIG. 20 is a flow diagram depicting an embodiment of a method 2000 to implement a learning process. At 2002, a user inserts (i.e., places) all required tools into a tool tray such as tool tray 106. At 2004, the user inserts a USB cable into an appropriate connector associated with the tool tray. In some embodiments, the connector is similar to connector 910. At 2006, a processing system similar to processing system 104 determines one or more positions associated with the tools in the tool tray. Some applications of the tool tray (e.g., a specific manufacturing process) may not require that all positions in the tool tray be populated with tools; rather, a user may need a lesser number of tools than can be accommodated by the tool tray. For example, a tool tray may have 8 positions but a user may need to use only 5 of those positions for a specific process. Method 2000 is a learning method that allows the processing system to learn (i.e., to determine), before the start of a manufacturing or operation process, which tools are present in the tool tray, and their corresponding positions in the tool tray.

At 2008, the user unplugs the USB cable into the connector, while at 2010, the user inserts the USB cable into the connector. At 2012, the method checks to see whether a certain number of iterations corresponding to the user unplugging and plugging in the USB cable is complete. In some embodiments, this number of iterations ranges from 2 to 5. If the number of iterations is not complete, the method returns back to 2006, after which the user goes through a next round of unplugging and plugging in the USB cable. On the other hand if, at 2012, the method determines that the number of iterations is complete, then the method goes to 2014, where the processing system performs a learning process, in which the processing system learns about what tools are present in specific locations of the tool tray. The method then terminates at 2016.

In some embodiments, the processing system uses software to detect an insertion or removal of the USB cable. Once a user has removed and inserted the USB cable a number of times equal to the number of iterations and leaves the USB cable disconnected, the processing system initiates a special LED sequence to inform the user that a learning process is being performed by the processing system (i.e., at step 2014); the sequence of removing and inserting the USB cable itself triggers the processing system to initiate the learning process. Once the LED sequence is complete, the user knows that the learning process is complete and they can continue to use the tool tray as they wish.

The description above presents a user performing the workflow associated with method 2000. In other embodiments, this workflow may instead be performed by an automated system such as a robotic actuator or some other kind of automated tool manipulation system.

Extensions of methods 1900 and 2000 that use USB cable connectivity can also be extended to a user repeatedly placing and removing a tool in a particular position in a tool tray. This process can be used to trigger additional functionality associated with the tool tray (e.g., getting feedback from a server regarding whether a particular tool is appropriate for a specific process).

Although the present disclosure is described in terms of certain example embodiments, other embodiments will be apparent to those of ordinary skill in the art, given the benefit of this disclosure, including embodiments that do not provide all of the benefits and features set forth herein, which are also within the scope of this disclosure. It is to be understood that other embodiments may be utilized, without departing from the scope of the present disclosure.

What is claimed is:

1. An apparatus comprising:
a remote server;
a processing system communicatively coupled to the remote server; and
a tool tray communicatively coupled to the processing system, wherein the tool tray is configured to store a plurality of tools, wherein the tool tray is configured to detect whether a tool has been removed from the tool tray, wherein the tool tray is configured to communicate information associated with the removal of the tool to the processing system, and wherein the processing system is configured to communicate the information to the remote server.

2. The apparatus of claim 1, further comprising a plurality of tool trays, wherein each tool tray is communicatively coupled with a processing system, and wherein each processing system is communicatively coupled with the remote server.

3. The apparatus of claim 1, wherein the detection is performed using one or more inductive sensors.

4. The apparatus of claim 3, wherein an inductive sensor is comprised of a resonant circuit that includes an inductor and a capacitor.

5. The apparatus of claim 4, wherein the resonant circuit operates within a resonant frequency range of 1 MHz to 10 MHz.

6. The apparatus of claim 3, wherein an inductive sensor detects a tool that is within a 5 mm distance of the inductive sensor.

7. The apparatus of claim 1, wherein the tools are any of one or more drill bits, a pair of pliers, a wrench, a screwdriver, or a punch.

8. The apparatus of claim 7, wherein the remote server determines a type of a tool that has been removed from the tool tray.

9. The apparatus of claim 8, wherein the remote server disables a machine, records an event for time sequencing, or sets an alert responsive to an incorrect tool being removed.

10. The apparatus of claim 1, further comprising:
a plurality of machines, wherein each machine is associated with a tool set; and
a plurality of tool trays, wherein each tool tray is associated with a machine of the plurality of machines, wherein each tool tray is configured to store a tool set associated with a machine, wherein the processing system is communicatively coupled to each tool tray, wherein each tool tray is configured to detect a removal of a tool from a tool set associated with the tool tray, wherein the tool tray is configured to communicate information associated with the removal to the processing system, wherein the processing system is configured to communicate the information to the remote server, and wherein the remote server is configured to disable one or more machines responsive to the remote server determining that an incorrect tool has been removed.

11. A method comprising:
monitoring, by a tool tray, a status of a plurality of tools stored in the tool tray;
detecting, by the tool tray, a removal of a tool from the tool tray;
communicating, by the tool tray to a processing system communicatively coupled to the tool tray, information associated with the removal of the tool; and
transmitting, by the processing system, the information to a remote server, wherein the processing system is communicatively coupled to the remote server.

12. The method of claim 11, further comprising a plurality of tool trays, wherein each tool tray is communicatively coupled with a processing system, and wherein each processing system is communicatively coupled with the remote server.

13. The method of claim 11, wherein the detection is performed using one or more inductive sensors.

14. The method of claim 13, wherein an inductive sensor is comprised of a resonant circuit that includes an inductor and a capacitor.

15. The method of claim 14, wherein the resonant circuit operates within a resonant frequency range of 1 MHz to 10 MHz.

16. The method of claim 13, wherein an inductive sensor detects a tool that is within a 5 mm distance of the inductive sensor.

17. The method of claim 11, wherein the tools are any of one or more drill bits, a pair of pliers, a wrench, a screwdriver, or a punch.

18. The method of claim 17, wherein the remote server determines a type of a tool that has been removed from the tool tray.

19. The method of claim 18, further comprising disabling, by the remote server, a machine responsive to an incorrect tool being removed.

20. The method of claim 11, wherein the processing system is communicatively coupled with the remote server using a WiFi communication link, a Bluetooth communication link, a ZigBee communication link, or a 5G communication link.
